(19) United States
(12) Patent Application Publication
(10) Pub. No.: US 2011/0159219 A1
(43) Pub. Date: Jun. 30, 2011

(54) SILICATE GLASS ARTICLE WITH A MODIFIED SURFACE

(75) Inventors: Yuanzheng Yue, Aalborg (DK); Morten Mattrup Smedskjaer, Aalborg (DK)

(73) Assignee: AALBORG UNIVERSITET, Aalborg Ø (DK)

(21) Appl. No.: 13/061,398

(22) PCT Filed: Sep. 3, 2009
(86) PCT No.: PCT/DK2009/050224

§ 371 Date: Feb. 28, 2011

(30) Foreign Application Priority Data
Sep. 5, 2008 (DK) PA 2008 01249

(51) Int. Cl. C03C 21/00; B32B 1/02; C03C 3/04; C03C 3/06; C03C 3/095; C03C 3/083; C03C 3/078; C03C 13/00; C03C 13/02

(52) U.S. Cl. 428/34.4; 65/30.14; 501/53; 501/54; 501/64; 501/68; 501/72; 501/35; 501/38

(57) ABSTRACT

The present invention relates to a silicate glass article, such as a glass container, with a modified surface region. The modified surface has, among other advantageous properties, an improved chemical durability, an increased hardness, and/or an increased thermal stability, such as thermal shock resistance. In particular the present invention relates to a process for modifying a surface region of a silicate glass article by heat-treatment at T_{g} in a reducing gas atmosphere such as H₂/N₂ (1/99). The concentration of network-modifying cations (NMC) in the surface region of the silicate glass article is lower than in the bulk part, and the composition in the surface region of the network-modifying cations is a consequence of an inward diffusion.

### TECHNICAL FIELD OF THE INVENTION

The present invention relates to a silicate glass article, such as a glass container, with a modified surface region. The modified surface has, among other advantageous properties, an improved chemical durability, an increased hardness, and/or an increased thermal stability, such as thermal shock resistance. In particular, the present invention relates to a process for modifying a surface region of a silicate glass article.

### BACKGROUND OF THE INVENTION

It is well known that surface characteristics have strong impact on the physical and chemical properties of glasses, and hence, on their applications. These properties can be tailor-made by using a surface modification technique, e.g., coating of metal oxides or polymers, ion exchange between glass and salt melt, fire polishing and so on. By modification of the surface, new functional surfaces can be created that can be applied in new contexts or in marked improvements of existing materials.

Earlier studies have shown that the surface of a Fe²⁺-bearing silicate glass article can be modified by using redox reactions. The new surface can be obtained by heat-treating the said glass article in atmospheric air at temperatures near the glass transition temperature (T_{g}) for suitable durations. The heat-treatment leads to oxidation of ferrous iron (Fe²⁺) to ferric iron (Fe³⁺), which causes a diffusion of divalent cations (primarily Mg²⁺) from the interior of the glass towards the surface (called outward diffusion). Surprisingly, the oxidation process does not cause oxygen to diffuse into said glass article to a significant degree as Fe³⁺ is formed due to reaction between electronic species (electron holes) and Fe²⁺. A crystalline layer forms on the surface of the glass article as the divalent cations react with oxygen at the surface. This surface layer exhibits excellent thermal performance, i.e., this finding has potential to be industrially applied. The effect of the surface layer on the physical and chemical properties (mechanical properties, chemical durability, inertness, optical properties, etc.) of glassy materials is still unknown.

Another study has shown that the physical and chemical properties of a glass article can be affected by the surface content of silica, as silica increases the connectivity of the glass structure [Dériano et al., 2004]. For example, an enhancement of the chemical durability of the glass is expected. Hence, their surface modification method has potential to be industrially applied, e.g., in the improvement of the chemical resistance of glass container for drugs and chemicals. Glass degradation can occur when liquids are corrosive.

In yet another study, Pind & Sørensen (2004) studied the redox and diffusion processes in a SiO₂—Al₂O₃—MgO—CaO—FeO/Fe₂O₃ glass system and prepared samples with Fe³⁺/Feₜₒₜ ratios of approximately 80%. One of these samples was heated in a reducing atmosphere (10/90 H₂/N₂). In this case, Mg²⁺ diffused from the surface towards the interior (called inward diffusion) as a mirror-image of the oxidation mechanism. The silicon concentration near the surface is increased as the silicon ions (Si⁴⁺) do not diffuse, i.e., a silica-rich nanolayer forms on the surface. Other studies dealing with reduction of ferric iron-bearing glasses in H₂ atmospheres have shown that permeation (dissolution and diffusion) of gaseous H₂ is the dominant reduction process, i.e., no inward diffusion of divalent cations occurs [Gaillard et al., 2003].

In a study by Rigato et al. (1994), it was shown that the thermochemical reduction of alkali-lead-silicate glass does not lead to any significant incorporation of hydrogen in the surface, but greatly sensitizes the surface to the chemical and physical adsorption of water. The treatment creates a thin (25 nm) compositionally modified layer, perhaps microporous, of silica-rich glass at the surface due to depletion of Pb where the hydrogen concentration due to adsorption is irreversible. The time and temperature of thermochemical treatment influence the initial kinetics of the adsorption. These observations are of practical significance to the behaviour of electron multiplier and microchannel plate devices that have been exposed to humid environments.

In a study by Deriano et al. (2004), it is described that mechanical properties of a soda-lime-silica glass can be improved by thermal treatment of the glass in N₂ and NH₃ gases. They argue that the observed strength improvement might be due to the reaction of water and ammonia with the glass. This causes an exchange process of network-modifying cations with protons. Hereby, the soda-lime-silica glass is turned into a glass of a high silica content by a process that is rate-limited by the diffusion of water.

The U.S. Pat. No. 3,460,927 describes a thermal treatment method that improves the flexural strength (the ability to resist deformation under load) of a polyvalent element-containing glass by reducing it in a hydrogen atmosphere. The treatment is carried out well below the glass transition temperature.

The understanding of the relation between redox reactions and diffusion processes near the surface of iron-containing silicate glasses in a reducing atmosphere is at present very limited due to results pointing in different directions.

If the surface of high silica content can be created, this would be economically more favourable than bulk silica (SiO₂) production as the latter requires very high temperatures (up to 2400° C.) for melting and forming.

Hence, an improved method to create silicate glass products with a relatively thick surface of high silica content would be advantageous as an economically more favourable option than using the expensive bulk silica in the production, or as a favourable option to the use of coatings of metal oxides or polymers, ion exchange between glass and salt melt, fire polishing and so on.

### SUMMARY OF THE INVENTION

Thus, an object of the present invention relates to improving the properties of silicate glass articles.

In particular, it is an object of the present invention to provide an improved silicate glass article that solves the above mentioned problems of the prior art with improved surface properties.

Thus, one aspect of the invention relates to a silicate glass article comprising a bulk part and a surface region, said silicate glass article comprises network-modifying cations (NMC); wherein the concentration of the network-modifying cations in the surface region is lower than in the bulk part, wherein the composition in the surface region of the network-modifying cations is a consequence of an inward diffusion.

The invention is particularly, but not exclusively, advantageous for obtaining an improved silicate glass article having improved chemical durability, an increased hardness, and/or an increased thermal stability. Without being bound by any specific theory, it is contemplated that the network modifying cations (NMC) occupy interstitial positions within the network and thereby create non-bridging oxygens. By lowering the concentration of the network modifying cations (NMC) in the surface region, a more connected network is created on the surface, which makes it difficult for ions to diffuse through the glass, and thus improves the chemical durability, e.g. acid and alkali resistance.

Similarly, the mechanical properties, e.g. the hardness, are augmented due to the increased connectivity of the surface layer resulting in an increased effective silica concentration in the said surface layer.

It could be an advantage, in addition to the increased connectivity of the surface region, to increase the thickness of said surface region to further improve the chemical durability, to increase the hardness, and/or to increase the thermal stability. To obtain a relatively high concentration of silica in the surface region, it may be contemplated that the glass type comprises a relatively large weight percentage of silica such as 10%, 20%, 30%, 40%, 50%, 60%, 70%, 80%, or 90%.

Therefore, in one embodiment, the silicate glass article according to the invention has a weight percentage of silica of at least 10-35%, preferably at least 30-49%, and even more preferably at least 50%. Other components than silicate may be comprised in the silicate glass article, such as alkali oxides, alkaline earth oxides and polyvalent metal oxides. In another embodiment, the silicate glass article according to the invention has a weight percentage of alkali oxides of at least 0-90%, such as 0.5-85%, preferably at least 1-80%, such as 3-75%, preferably at least 5-50%, such as 7-30%, preferably at least 10-20%. In yet another embodiment, the silicate glass article according to the invention has a weight percentage of alkaline earth oxides of at least 0-90%, such as 0.5-85%, preferably at least 1-80%, such as 3-75%, preferably at least 5-50%, such as 7-30%, preferably at least 10-20%.

In still another embodiment, the silicate glass article according to the invention has a weight percentage of polyvalent metal oxides of at least 0.001-90%, such as 0.5-85%, preferably at least 1-80%, such as 3-75%, preferably at least 5-50%, such as 7-30%, preferably at least 10-20%.

The surface layer exerts a strong impact on the surface properties as silica increases the connectivity of the glass. In particular, it considerably enhances the chemical durability (in both acid and alkali solutions) and the hardness of the glass.

Therefore, in another embodiment, the silicate glass article according to the invention has a silicate bridging oxygen content that is substantially higher in the surface region than in the bulk region, i.e. the network connectivity of the surface region is higher than that of the bulk region.

In particular, in one embodiment of the invention, the silicate glass article according to the invention has a decrease in the number of non-bridging oxygen atoms per tetrahedron, NBO/T, in the surface region of at least 10%, 20%, 30%, 40%, 50%, 60%, 70%, 80%, 90%, or 100%.

In yet another embodiment, the silicate glass article according to the invention has a concentration of SiO₂ in the surface region that is substantially higher than in the bulk part.

Oxidation of an iron-bearing glass by thermal treatment in atmospheric air causes the Mg²⁺, Ca²⁺, and Fe²⁺ ions to diffuse from the interior towards the surface (called outward diffusion). This observation is consistent with the results of previous studies based on basaltic glass systems. The diffusion of Mg²⁺ is predominant in the overall diffusion process, and at the surface, Mg²⁺ ions react with external oxygen to form periclase (MgO) crystals. The Fe²⁺ ions that diffuse to the surface are oxidized to Fe³⁺ at the surface. The surface region or layer enhances the hardness of the glass and protects it from attack of an acid solution, but makes it more vulnerable against an alkali solution.

A striking phenomenon has been observed as the outward diffusion of divalent cations does not only occur under an oxidizing atmosphere of heat-treatment, but also under N₂, even under a reducing atmosphere like H₂/N₂ (10/90 v/v) at the ambient condition. The outward diffusion causes the formation of an oxide nanolayer on the glass surface that possesses morphology and concentration profile different from those of the crystalline layer created when heating the glass in air. The extent of the cationic diffusion depends on temperature and duration of the heat-treatment. It has been proposed that the outward diffusion in N₂ and H₂/N₂ (10/90) is related to thermal nitridation (nitrogen incorporation), i.e., the mechanism of the outward diffusion depends on the type of gas used for the heat-treatment. The reduction of Fe³⁺ to Fe²⁺ or V⁵⁺ to V⁴⁺ in H₂/N₂ (10/90) operates by permeation of H₂ into the glass. Thus, hydroxyl groups form and are incorporated into the glass structure. The incorporation of hydroxyl groups increases the rate of the cationic diffusion even though the reduction of Fe³⁺ does not cause the diffusion in H₂/N₂ (10/90). Furthermore, the created OH groups reduce the stability of the glass against crystallization and the mechanical properties of the glass.

Surprisingly, it has been found by the inventors of the present invention that when the glasses are heated in H₂/N₂ (1/99), both H₂ permeation and outward diffusion of electron holes contribute to the reduction of Fe³⁺ to Fe²⁺ or V⁵⁺ to V⁴⁺. Diffusion of the electron holes is charge-compensated by an inward diffusion of the mobile network modifying cations (primarily Mg²⁺, Ca²⁺, and Fe²⁺). Consequently, a silica-rich nanolayer forms on the surface of the glass as the Si⁴⁺ ions do not diffuse. Therefore, in a further embodiment according to the invention, the inward diffusion is caused by reduction by a reducing gas and/or a reducing liquid.

The thickness of the silica-rich layer can be controlled by the content of the polyvalent element. Therefore, in another embodiment according to the invention, the depth of the surface region is a function of the inward diffusion process. In still another embodiment according to the invention, the composition in the surface region of the network-modifying cations is a consequence of inward diffusion, wherein the inward diffusion is caused by reduction of a polyvalent element.

It may be advantageous if the reduced element has lower mobility than the earth alkaline ions in the glass network.

The thickness of the silica-rich layer can also be controlled by tuning the temperature and duration of the heat. Therefore, in still another embodiment according to the invention, the depth of the surface region is a function of time, temperature, field strength of diffusing ions, partial pressure of the reducing gas, concentration and redox ratio of a polyvalent element, and/or glass type. Hence, the layer thickness can be tuned according to specific requirements.

A kinetic analysis has verified the diffusion mechanism of the present invention as being characterized by chemical diffusion and the diffusion coefficients for the divalent cations have been calculated. Therefore, in yet another embodiment according to the invention, the diffusion is characterized by chemical diffusion. The diffusion is rate-limited by the reduction kinetics in a manner where the diffusion is parabolic with time.

There could be different criteria for selecting a polyvalent element in the production of a glass article.

The polyvalent element should in certain embodiments of the invention have a redox state that is relatively easy to reduce in a weak reducing atmosphere, e.g. in about 0.001, 0.01, 0.02, 0.03, 0.07, or 0.09 bar H₂.

For some glass articles, the element and the redox state may determine the color of the glass article depending on the glass application, e.g. transparency of glass, specific color for a specific application, art glass, specific UV-absorption to protect, e.g., medicals, beer, wine, and other liquids or chemicals from degradation.

In yet another embodiment, the present invention relates to a silicate glass article, said silicate glass article being: a glass container for storage of chemicals, a glass fiber, art glass, a glass container for storage of beer, wine, and other liquids. In particular, the present invention is advantageous for storage of harsh or aggressive chemicals or for use in mechanically harmful environments.

Therefore, in a further embodiment according to the invention, the silicate glass is transparent in the optical range of 10-1200 nm, preferably in the visible range of 380-750 nm.

In still a further embodiment of the present invention, the silicate glass is capable of absorbing UV-light in the range of between 400-10 nm, 400-315 nm, 315-280 nm, or 280-100 nm, preferably in the range of between 400-100 nm.

The Vickers hardness (Hᵥ) test has been developed as a method to measure the hardness of materials. In the present invention, the Vickers hardness measurements reveal that the heat-treated glasses are harder than the original glass. The hardness increases with duration and temperature of the heat-treatment, i.e., the hardness increases when the thickness of the modified layer increases.

Therefore, in a preferred embodiment of the present invention, the silicate glass article has a hardness of the silicate glass that is substantially higher in said surface region than in the corresponding surface region of untreated glass, e.g. at least +10%, +20%, +30%, +40%, +50%, +100%, +200%, +300%, +1000% higher Hᵥ.

The said nanolayer exerts a strong impact on the surface properties as silica increases the connectivity of the glass. In particular, it may considerably enhance the chemical durability in both acid and alkali solutions. In acid solutions, leaching of alkali ions from the glass is the dominant dissolution mechanism. In one example of the present invention (FIG. 6B), the sodium leached from the glass article into a HCl solution is decreased more than five times as compared to the untreated glass.

Therefore, in a preferred embodiment of the present invention, the silicate glass article has a chemical durability in the said surface region that is substantially higher than in the corresponding surface region of untreated glass, e.g. at least 1.1, 1.2, 1.3, 1.4, 1.5, 1.6, 1.7, 1.8, 1.9, 2, 3, 5, 10, 30, 50, 100, 1000 times better than in the corresponding surface region of untreated glass.

The modified surface has, among other advantageous properties, an increased thermal stability, such as thermal shock resistance.

Therefore, in a preferred embodiment of the present invention, the silicate glass article has a thermal shock resistance that is substantially higher than the thermal shock resistance of the corresponding untreated glass, e.g. at least 1.5, 2, 3, 5, 10, 30, 50, 100, 1000 times better than the thermal shock resistance of the corresponding untreated glass.

The thickness of the silica-rich layer may be controlled by the content and reduction of the polyvalent element.

In a preferred embodiment of the present invention, the silicate glass article comprises transition metallic cations.

In still a preferred embodiment, the present invention relates to a silicate glass article wherein at least some of the transition metallic cations are network-modifying cations (NMC).

In another embodiment, the present invention relates to a silicate glass article, wherein at least some of the network-modifying cations (NMC) are from Group IIa in the Periodic Table, e.g. Be²⁺, Mg²⁺, Ca²⁺, Sr²⁺, Ba²⁺, and Ra²⁺.

In still another embodiment, the present invention relates to a silicate glass article, wherein the polyvalent element is selected from a group consisting of: Au, Ir, Pt, Pd, Ni, Rh, Co, Mn, Ag, Se, Ce, Cr, Sb, Cu, U, Fe, As, Te, V, Bi, Eu, Ti, Sn, Zn, and Cd.

In another embodiment, the present invention relates to a silicate glass article, wherein the transition metallic cations are selected from a group consisting of: Ti⁴⁺, Ti³⁺, V⁵⁺, V⁴⁺, V³⁺, Cr⁶⁺, Cr⁵⁺, Cr³⁺, Mn⁷⁺, Mn⁶⁺, Mn⁵⁺, Mn⁴⁺, Mn³⁺, Fe⁵⁺, Fe⁴⁺, Fe³⁺, Co⁴⁺, Co³⁺ and Ni³⁺.

In still another embodiment, the present invention relates to a silicate glass article, wherein the transition metallic cations are selected from a group consisting of: Ti²⁺, V²⁺, Cr²⁺, Mn²⁺, Fe²⁺, Co²⁺, Ni²⁺, Cu²⁺, Zn²⁺, Zr²⁺, Nb²⁺, Mo²⁺, Ru²⁺, Rh²⁺, Pd²⁺, Ag²⁺, Cd²⁺, Ta²⁺, W²⁺, Re²⁺, Os²⁺, Ir²⁺, Pt²⁺, Hg²⁺ and Ra²⁺.

The process of the invention leads to a silicate glass article with a surface of high silica content, thereby avoiding the need to produce glass articles of the bulk silica glass. The latter requires very high temperature (up to 2400° C.) for melting and forming. Therefore, the present invention is economically more favorable than bulk silica glass production.

The invention creates an improved silicate glass article, having improved chemical durability, an increased hardness, and/or an increased thermal stability, without using the extrinsic coating technology that requires additionally expensive raw materials.

Thus, another aspect of the invention relates to a process for modifying a surface region of a silicate glass article, said process comprises the step of heat-treating the silicate glass article in an atmosphere comprising a reducing gas, said process resulting in an inward diffusion of the network-modifying cations (NMC) into deeper regions of the silicate glass article, whereby the concentration of the network-modifying cations in the surface region is lowered.

Yet another aspect of the invention relates to said process, wherein the reducing gas is a mixture of one or more reducing gasses.

Still another aspect of the invention relates to said process, wherein the reducing gas is further mixed with one or more inert gasses.

A preferred aspect of the invention relates to said process, wherein the atmosphere comprises a mixture of nitrogen gas and hydrogen gas.

Another preferred aspect of the invention relates to said process, wherein the atmosphere comprises a mixture of carbon monoxide gas and carbon dioxide gas.

Still a preferred aspect of the invention relates to said process, wherein the atmosphere comprises a mixture of gasses selected from a group consisting of: SbH₃, AsH₃, B₂H₆, CH₄, PH₃, SeH₂, SiH₄, SH₂, Sn H₄, Cl₂, NO, N₂O, CO, H₂, N₂O₄, SO₂, C₂H₄, and NH₃.

In order to obtain inward diffusion in a glass article, caused by reduction of a polyvalent element, it is currently considered essential that the permeation of the reducing gas is not dominating said reduction.

A preferred aspect of the invention relates to said process, wherein the reducing gas is substantially impermeable in the untreated silicate glass.

It could be an advantage, in addition to the increased connectivity of the surface region or layer, to increase the thickness of said surface region to further improve the chemical durability, to increase the hardness, and/or to increase the thermal stability.

Thus, a preferred aspect of the invention relates to said process, wherein the heat-treatment is performed so as to obtain a thickness of said surface region of at least 100 nm, 200 nm, 400 nm, 500 nm, 600 nm, 700 nm, 1000 nm, 1500 nm, or 3000 nm.

The thickness of the silica-rich layer can be controlled by tuning the temperature and duration of the heat-treatment.

Thus, a preferred aspect of the invention relates to said process, wherein the heat-treatment is performed at e.g. 0.1-3.0, 0.5-3.0, 0.6-3.0, 0.7-3.0, 0.8-2.0, or 0.9-2.0 times the glass transition temperature (T_{g}) of the silicate glass.

Another aspect of the invention relates to said process, wherein the heat-treatment is performed in the interval of 0.001-36, 0.01-36, 0.1-36, 0.1-30, 0.1-24, 0.2-36, 0.2-34, 0.2-20, 0.3-36, 0.3-25, 0.3-18, 0.4-36, 0.4-27, 0.4-12, 0.5-36, 0.5-15, 1-5, 1-4, or 1-3 hours. Even shorter or longer times are within the teaching of the invention.

Regulating the pressure of the surrounding atmosphere in said process has an important impact on the temperature and/or duration of heat-treatment.

Yet another aspect of the invention relates to said process, wherein the pressure of the said atmosphere in the interval of 0.001-20 atm., 0.001-10 atm., 0.01-10 atm., 0.01-5 atm., 0.1-5 atm., or 1-10 atm. Any of the lower limits in the said intervals may also be minimum values.

### BRIEF DESCRIPTION OF THE FIGURES

The invention will now be described in further details in the following non-limiting examples.

FIGS. 1A-B show schematic representations of different proposed mechanisms of surface modification, 1A shows the formation of an MgO/CaO layer, 1B shows the formation of a silica-rich layer,

FIG. 2A-D show schematic representations of SNMS depth profiles of the untreated 6 wtFe glass and of the 6 wtFe glass heated in H₂/N₂ (1/99) at different conditions, 2A shows a profile of the original 6 wtFe glass, 2B shows a profile of the 6 wtFe glass heated at T_{g} for 2 hours, 2C shows a profile of the 6 wtFe glass heated at T_{g} for 16 hours, 2D shows a profile of the 6 wtFe glass heated at 1.05 T_{g} for 2 hours,

FIG. 3A-D show schematic representations of FT-IR reflectance spectra of the untreated and heat-treated 6 wtFe glass at different conditions, 3A shows a spectra of the 6 wtFe glass heated at T_{g} for different durations in H₂/N₂ (10/90), 3B shows a spectra of the 6 wtFe glass heated for 2 hours at different temperatures in H₂/N₂ (10/90), 3C shows a spectra of the 6 wtFe glass heated at T_{g} for different durations in H₂/N₂ (1/99), 3D shows a spectra of the 6 wtFe glass heated for 2 hours at different temperatures in H₂/N₂ (1/99),

FIG. 4A shows a plot of squared thickness of the divalent-cation-depleted region (Δξ) versus heat-treatment duration (tₐ) for the 6 wtFe glass samples in H₂/N₂ (1/99) at T_{g}, FIG. 4B shows a table describing the dependence of the difference in the Fe²⁺ concentration before and after treatment (Δc(Fe²⁺)) on the initial iron-content of the glass and the heat-treatment condition, 4C shows CEMS spectra of 6 wtFe glasses (untreated, heated in air at T_{g} for 16 h, and heated in H₂/N₂ (1/99) at T_{g} for 16 h,

FIG. 5A shows a UV-VIS-NIR spectra of 0.20 mm thick 6 wtFe glass samples heated in H₂/N₂ (1/99) at T_{g} for different durations, 5B shows the corresponding Fe²⁺ concentrations expressed as the dependence of the difference in the Fe²⁺ concentration before and after treatment (Δc(Fe²⁺)) on the heat-treatment duration (tₐ),

FIG. 6A shows a table with data of Vickers hardness and water contact angle of the untreated and thermally treated 6 wtFe glasses at different temperatures and durations, 6B shows a table with data of chemical durability of the untreated and thermally treated 6 wtFe glasses at different temperatures and durations, and

FIG. 7 shows a schematic overview of the experimental strategy and the employed analytical techniques, and

FIG. 8 shows viscosity as a function of temperature for the SiO₂—CaO—Fe₂O₃-A₂O glasses with A=Na, K, Rb, Cs, and

FIG. 9 shows Arrhenius plot of In k′ as a function of the reciprocal absolute temperature of the SiO₂—CaO—Fe₂O₃-A₂O (A=Na, K, Rb, Cs) glasses that have been heat-treated in H₂/N₂ (1/99) at different temperatures for 2 h, inset shows the activation energy of calcium diffusion E_{d} as a function of both the ionic radius r_{A} of the alkali ions (open circles) and the fragility index m (closed circles), and

FIG. 10 shows normalized mass change Δm/m₀, where Δm and m₀ are the mass change and the initial mass of the sample, respectively, of the seven as-prepared glasses as a function of temperature T, the mass change was measured at an upscanning rate of 10° C./min in air, normalized mass change Δm/m₀ of the Cr-containing glass as a function of time t at T_{g}=633° C. in air, and

FIG. 11 shows the onset crystallization temperature T_{c} as a function of Δn_{rel,dyn}, Δn_{rel,dyn} is the normalized number of moles of the polyvalent element that were oxidized during dynamic heating in air at 10° C./min to 975° C., T_{c} was determined from a DSC experiment performed at 10° C./min in air, and

FIG. 12 shows SNMS peak area of Ca²⁺ for the seven glasses heat-treated in air at their respective T_{g} for 6 h as a function of Δn_{rel,iso}, the areas are calculated between the SNMS concentration curves of Ca²⁺ and the horizontal line through c=c_{bulk}, Δn_{rel,iso} is the normalized number of moles of the polyvalent element that were oxidized during iso-thermal heating in air at T_{g} for 6 h, the dashed line represents a linear fit, and

FIG. 13 shows diffusion depths (Δξ) of the alkaline earth ions as a function of the ionic radius r, the glasses have been heat-treated in H₂/N₂ (1/99) at their respective T_{g} for different durations (tₐ), closed squares show tₐ=16 h, open squares show tₐ=2 h, inset shows plot of)² against tₐ (0.5, 2, 8, and 16 h) at Tₐ=T_{g} for the Mg-containing glass, and

FIG. 14 shows Arrhenius plot of In k′ as a function of the reciprocal absolute temperature of the SiO₂—Na₂O—Fe₂O₃—RO glasses with R═Mg, Ca, Sr, Ba heat-treated in H₂/N₂ (1/99) at different conditions, closed squares: R═Mg, open squares: R═Ca, closed triangles show R═Sr, open triangles show R═Ba, inset shows the corresponding activation energies of diffusion (E_{d}) as a function of the ionic radii of the alkaline earth ions (r), and

FIG. 15 shows activation energy of diffusion around T_{g} (E_{d}) versus the fragility index m, and the activation energy of viscous flow at T_{g} (E_{η}), and

FIG. 16 shows UV-VIS-NIR spectra of 0.20 mm thick 6 wtFe glass samples: untreated and heated in H₂/N₂ (1/99) and CO/CO₂ (98/2) at T_{g}=926 K for 16 h, and

FIG. 17 shows SNMS depth profiles of the 6 wtFe glass heat-treated in CO/CO₂ (98/2) at T_{g}=926 K for 16 h, the curves are plotted as concentration of the element at a given depth divided by the concentration of the same element in the bulk of the glass (C/C_{bulk}).

The present invention will now be described in more detail in the following.

### DETAILED DESCRIPTION OF THE INVENTION

### Definitions

Prior to discussing the present invention in further details, the following terms and conventions will first be defined:

### Polyvalent Element:

The term “polyvalent element” can be found in numerous articles in the field of glass science and technology. In the present context this term will refer to an element which may exist in different redox states. The best direct definition one may find in Pye et al. (2005) p. 28: “In this chapter, all those elements will be considered to be polyvalent, which may occur in a glass melt in at least two different oxidation states, even if extreme oxidizing or reducing conditions are necessary.”

### Network Modifying Cation:

The following definition is found in Shelby (2005) p. 10: “Finally, cations which have very low electronegativities (group III), and therefore form highly ionic bonds with oxygen, never act as network formers. Since these ions only serve to modify the network structure created by the network forming oxides, they are termed modifiers.”

### The Glass Transition Temperature (T_{g}):

The glass transition temperature (T_{g}) is defined as the onset of change of heat capacity due to the glass transition when heating a glass as defined in Shelby (2005).

It is a preferred object of the present invention to provide an improved silicate glass article that solves the above mentioned problems of the prior art with improved surface properties.

Cooling of a melt can lead to the formation of either glass or crystals dependent on the cooling rate [Shelby, 2005]. The crystalline and glassy materials might have the same composition, but they differ in structure as crystals have a more ordered structure than glasses. To discuss the theory of glass formation, two terms need to be defined: short-range order (SRO) and long-range order (LRO). SRO exists when the local atomic bonding units (nearest neighbour configuration of atoms) are uniform in the entire solid. LRO exists when the arrangement of atoms in space is periodic [Gersten & Smith, 2001]. Present no ideal definition of a glass exists. A possible definition is, an amorphous solid completely lacking LRO, and exhibiting a region of glass transformation behaviour. The SRO existing in a given glass is ideally identical to that found in the corresponding crystals. Crystals are defined to be solids with perfect LRO which implies perfect periodicity of the atomic arrangement.

Different theories regarding the structure of oxide glasses exist, but the random network theory is the most commonly used model [Shelby, 2005]. The atoms in a glass form a continuous random network where SRO exists. The conditions for the formation of a continuous three-dimensional network are [Zachariasen, 1932]:

1) An oxygen atom is linked to not more than two cations.
2) The oxygen coordination number of the network cation must be small.
3) The oxygen polyhedra share corners with each others, not edges or faces.
4) At least three corners in each oxygen polyhedra must be shared in order to form a three-dimensional network.

As these rules give no indication of the degree of LRO of the network, they describe the structure of both glasses and many crystalline solids. Therefore, an additional requirement was added by Zachariasen such that the rules only explain glass formation. The network must be distorted in a way that destroys the LRO. This distortion can be achieved by variation in bond lengths or angles as well as by rotations of structural units about their axes

The chemical components in an oxide glass can be divided into different categories according to their role in the structural arrangement of the glass. Stanworth (1971) has classified oxides into three groups based on the electronegativity of the cation, i.e., the oxides are classified according to the fractional ionic character of the cation-anion bond as the anion is oxygen in every case. If the cation forms bonds with oxygen with a fractional ionic character near or below 50%, the cation will act as a network former [Shelby, 2005]. All glasses contain at least one network former as it is the primary source of the structure.

In silicate glasses, silicon acts as the network former and it exists as silicon-oxygen tetrahedral that are linked by bridging oxygen (BO) atoms. The tetrahedral themselves are very ordered. The required lack of LRO is introduced by variability in the Si—O—Si angle, rotation of adjacent tetrahedral around the point occupied by the oxygen atom linking the tetrahedral, and rotation of the tetrahedral around the line connecting the linking oxygen with one of the silicon atoms [Shelby, 2005]. Cations which form highly ionic bonds with oxygen are termed network modifiers as they only serve to modify/interfere with the network structure without becoming part of the primary network [Shelby, 2005]. Network modifiers provide non-bridging oxygen (NBO) atoms with a negative charge as they are introduced as oxides and have coordination number 6. The cations reside in interstitial sites of the network to maintain local charge neutrality. Both alkali (e.g., Na⁺ and K⁺) and alkaline earth (e.g., Ca²⁺ and Mg²⁺) ions can act as modifiers. Every alkali ion has one neighbouring NBO, while every alkaline earth ion has two neighbouring NBOs. The strength of the network is dependent on the amount of network formers and modifiers. An increase in the amount of network modifiers results in an increase in the amount of NBOs which decreases the connectivity (or the degree of polymerization) of the. This lowers the melting temperature and several other properties of the glass [Shelby, 2005].

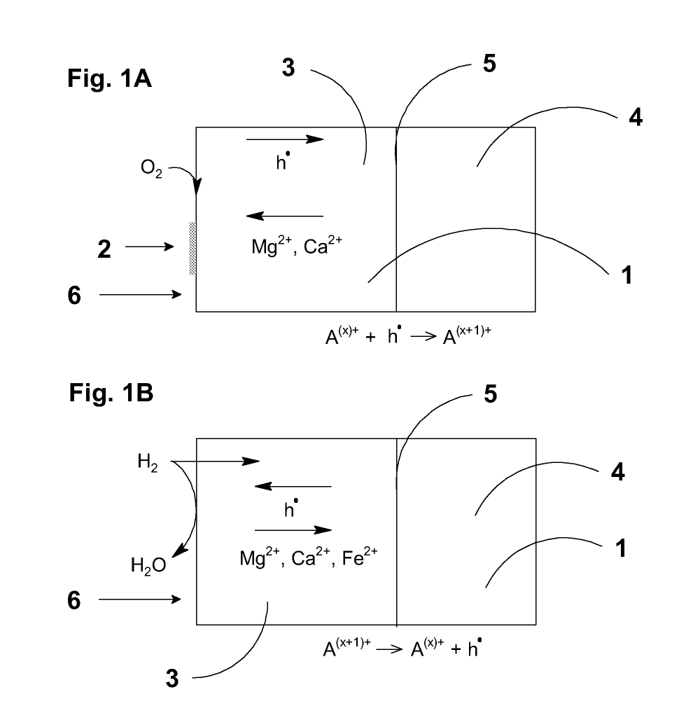

FIGS. 1A-B show schematic representations of two proposed mechanisms of surface modification, for explaining the present invention.

FIG. 1A shows a known mechanism for the formation of a crystalline MgO/CaO layer 2 on a silicate glass sample or article 1 comprising Mg²⁺, Ca²⁺ and Fe³⁺. The glass sample 1 is illustrated as having a surface 6, a surface region 3, a bulk part 4, and a so-called redox front 5. The heat-treatment leads to oxidation of ferrous iron (Fe²⁺) to ferric iron (Fe³⁺), which causes an outward diffusion of divalent cations (primarily Mg²⁺) from the interior of the glass towards the surface. A crystalline layer 2 forms on the surface 6 as the divalent cations react with ionic oxygen at the surface. This surface layer 2 exhibits excellent thermal performance.

FIG. 1B shows a mechanism according to the present invention for the formation of a silica-rich layer in the surface region 3. The schematic representation is a still shoot of a dynamic process. At the redox front 5, the Fe³⁺ ions are converted to Fe²⁺ ions and electron holes (h^{}). The extremely low partial oxygen pressure in the atmosphere provides a large driving force for the removal of oxygen from the glass article 1. At the surface, oxygen anions surrender two electrons to fill the h^{} and are subsequently released from the free surface 6 via reaction with H₂ to form H₂O. The diffusion of h^{} towards the surface is charge-balanced by an inward migration of the divalent cations (including Fe²⁺) as a mirror-image of the oxidation mechanism. Hence, the inward diffusion is driven by reduction of the high valence to the low valence state of the polyvalent element. As the network modifying cations (in this example Mg²⁺, Ca²⁺ and Fe³⁺) leave the surface without the diffusion of Si⁴⁺ ions, a silica-rich surface layer 3 is formed. Even though oxygen anions surrender the electrons to h^{} at the surface, H₂ molecules in the surrounding atmosphere are ultimately the source of the electrons.

Thus, one aspect of the invention relates to a silicate glass article 1 comprising a bulk part 4 and a surface region 3, said silicate glass article comprises network-modifying cations (NMC), e.g. Mg²⁺, Ca²⁺, and Fe²⁺ as indicated in the FIG. 1B. The concentration of the network-modifying cations (NMC) in the surface region 3 is lower than in the bulk part 4, and generally speaking the composition in the surface region of the network-modifying cations is a consequence of above-mentioned inward diffusion as it will be explained in more detail below.

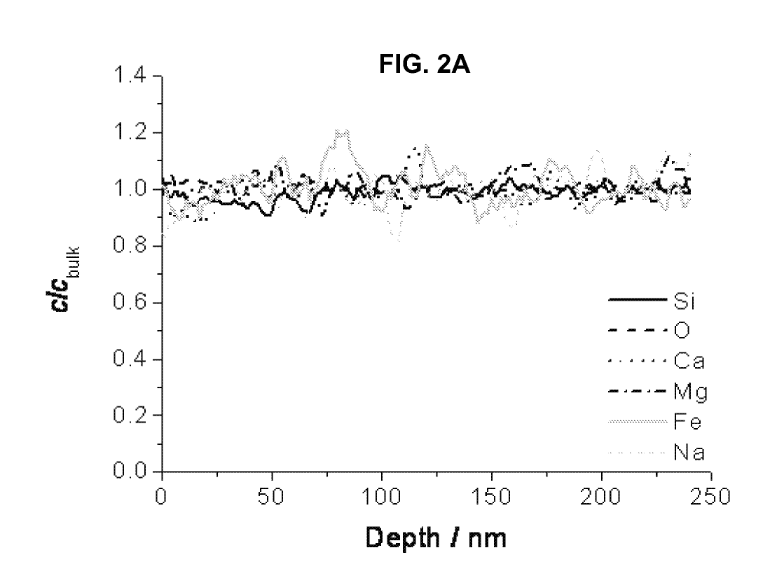

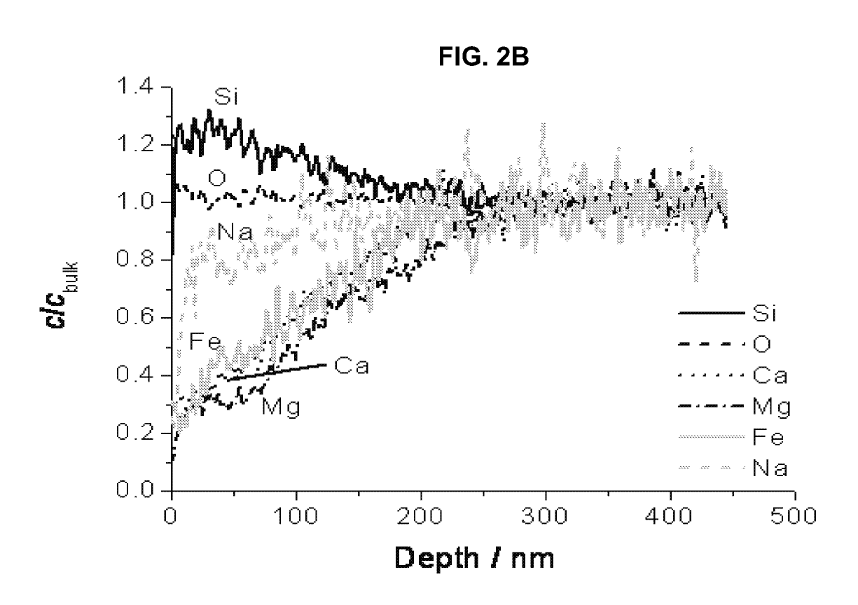

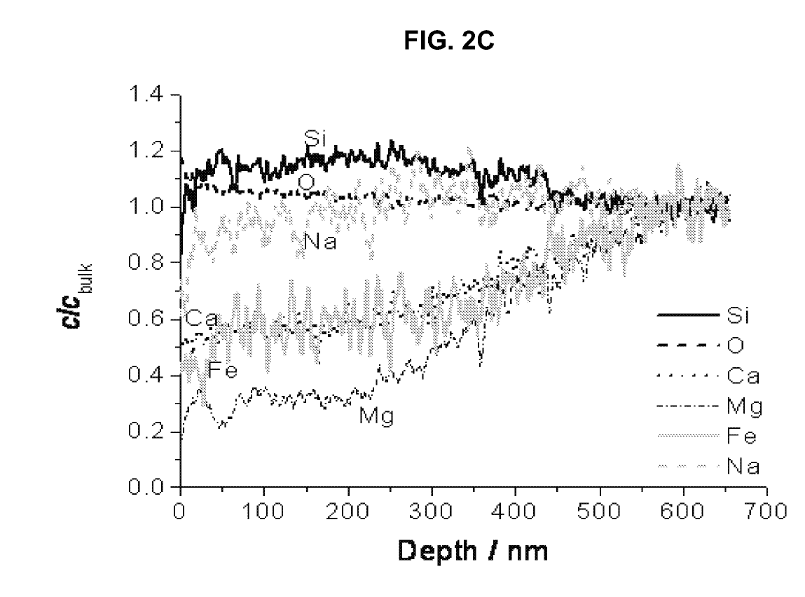

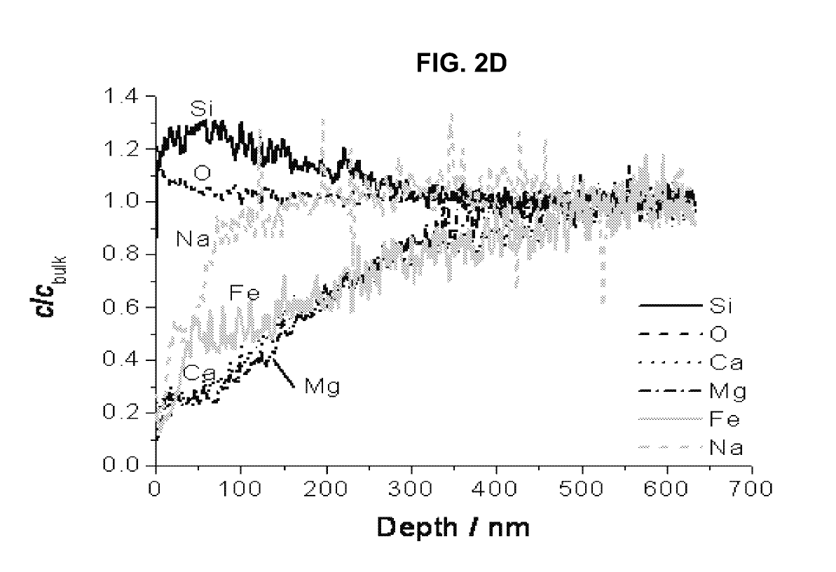

FIG. 2A-D show schematic representations of secondary neutral mass spectroscopy (SNMS) depth profiles of the original 6 wtFe glass and of the 6 wtFe glass heated in H₂/N₂ (1/99) at different conditions. The depth profile of each element is normalised to the bulk concentration. The H₂ partial pressure is lowered to 0.01 bars in order to create the silica-rich surface by decreasing the rate of the gaseous permeation. SNMS depth profiles show that this effort was successful. The chemical composition of the glasses and various other relevant data is given in Table 1 below:

TABLE 1
Chemical composition, iron redox ratio, density, glass transition
temperature (T_{g}), and NBO/T of the starting materials. The
calculation of NBO/T is explained in the text below.

| Glass | Chemical composition [wt %] | | | | | | Fe³⁺/Feₜₒₜ | Density | T_{g} | |
|---|---|---|---|---|---|---|---|---|---|---|
| ID | SiO₂ | CaO | MgO | Na₂O | Fe₂O₃* | V₂O₅ | [at %] | [g/cm³] | [° C.] | NBO/T |
| 0 wtFe | 74.3 | 10.8 | 10.2 | 4.43 | — | — | — | 2.501 | 644 | 0.84 |
| 1 wtFe | 72.5 | 11.4 | 9.95 | 4.63 | 1.09 | — | 35-50 | 2.517 | 641 | 0.87 |
| 3 wtFe | 70.8 | 11.1 | 9.59 | 4.49 | 3.14 | — | 60-75 | 2.549 | 648 | 0.84 |
| 6 wtFe | 69.4 | 10.8 | 9.34 | 4.41 | 6.07 | — | 69 ± 3 | 2.600 | 653 | 0.81 |
| 1 wtV | 72.7 | 11.4 | 9.96 | 4.68 | — | 1.03 | — | 2.533 | 653 | — |

*All iron is reported as Fe₂O₃

To characterize the network connectivity of the glasses, the number of non-bridging oxygen atoms per tetrahedron (NBO/T) is calculated from the chemical compositions. The following formula is used [Zotov et al., 1992]:

$$NBO / T = \frac{2 ( [ {Na}_{2} O ] + [ MgO ] + [ CaO ] + [ FeO ] - [ {Fe}_{2} {O}_{3} ] )}{[ {SiO}_{2} ] + 2 [ {Fe}_{2} {O}_{3} ]}$$

where the quantities in the square brackets denote the number of moles of each oxide. For 1 wtFe and 3 wtFe, the centre values of the stated iron redox ratio intervals have been used for the calculation. For the vanadium containing glass, V⁵⁺ is regarded as a former and V⁴⁺ as a modifier. However, as the initial vanadium redox ratio has not been determined, the calculation of NBO/T cannot be performed. For the iron-containing glasses, T_{g} increases with increasing glass connectivity (decreasing NBO/T), which is as expected. The relatively high T_{g} of 1 wtV indicates that most of the vanadium is present in the V⁵⁺ state.

### Calculation of NBO/T in Surface Layer

NBO/T for the untreated 6 wtFe glass is 0.81 as stated in Table 1. By using the SNMS (concentration of elements), CEMS (redox state of iron) and FT-IR (concentration of OH groups) data, the inventors have calculated the NBO/T ratio in a 200 nm surface layer of the glass treated in H₂/N₂ (1/99 v/v) at T_{g} for 16 h. This surface layer has NBO/T ˜0.45. This is the only sample for which the inventors at present have calculated NBO/T.

FIG. 2A shows a profile of the original 6 wtFe glass. The depth profile of the untreated glass reveals that the ion concentrations do not vary with depth.

FIG. 2B shows a profile of the 6 wtFe glass heated at T_{g} for 2 hours. Heat-treatment of the 6 wtFe glass under a H₂/N₂ (1/99) gas at T_{g}, for 2 h leads to the inward migration of the divalent cations and a remarkable increase in the silica concentration near the surface.

2C shows a profile of the 6 wtFe glass heated at T_{g} for 16 hours. Thus, by increasing the duration of the heat-treatment it is possible to increase the thickness of the modified surface layer as evident from comparison with FIG. 2B.

2D shows a profile of the 6 wtFe glass heated at 1.05 T_{g} for 2 hours. Upon comparison with FIG. 2B, it is seen that by increasing the temperature of the heat-treatment, the result is an increase in the thickness of the modified surface layer, i.e. the depth resulting from the combined heating and reduction according to the present invention is larger.

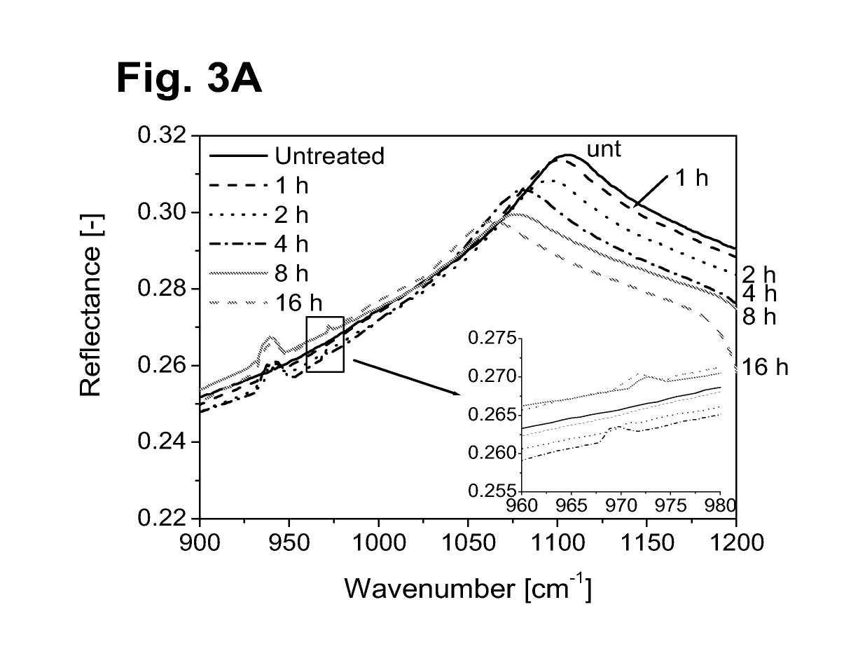

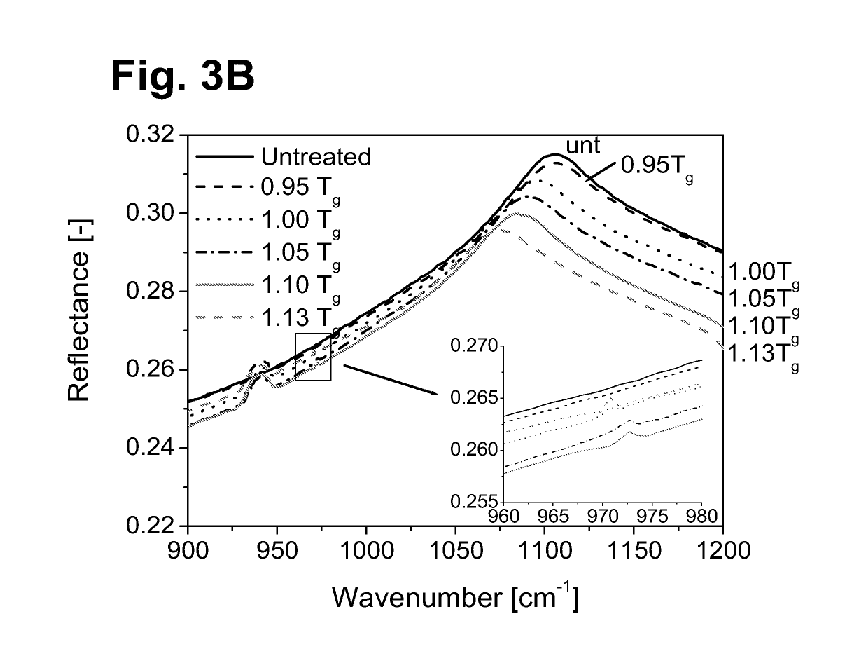

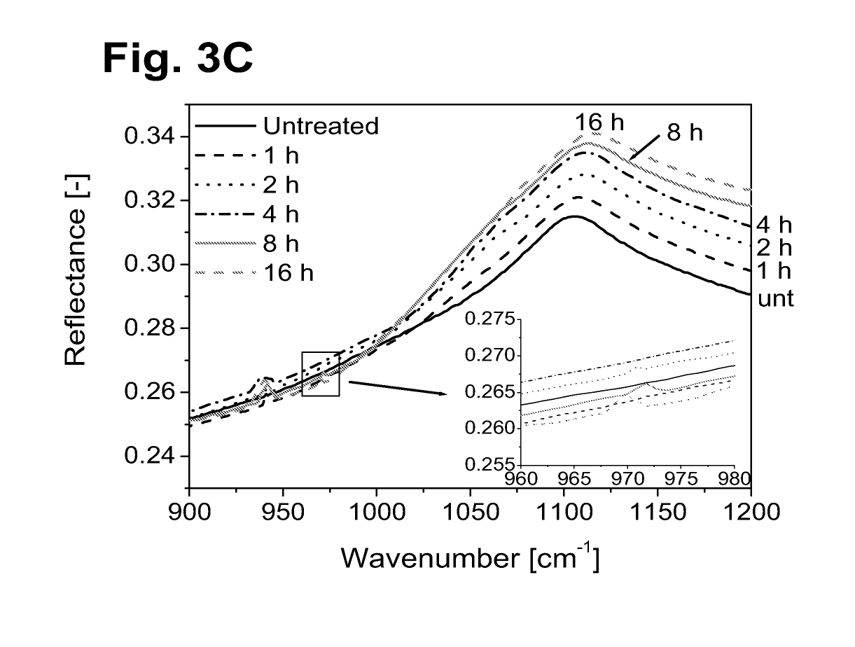

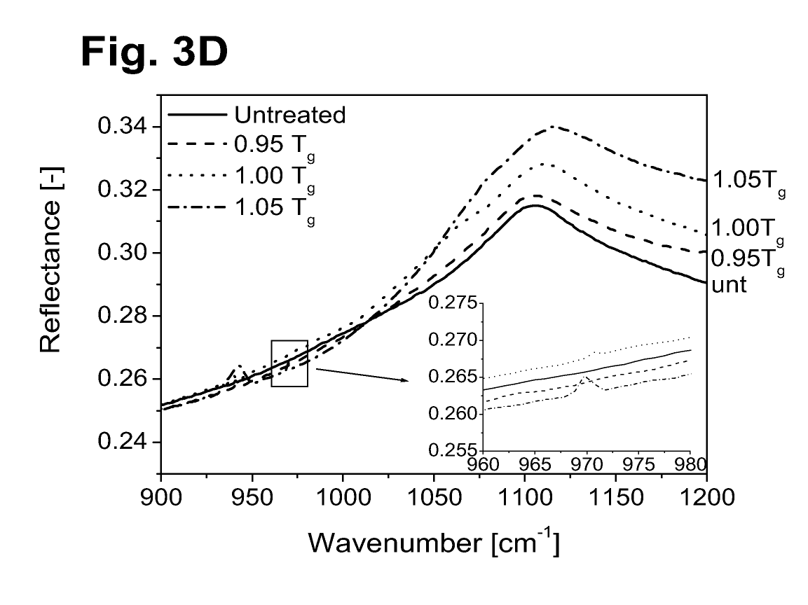

FIG. 3A-D show schematic representations of FT-IR reflectance spectra of the untreated and heat-treated 6 wtFe glass at different conditions. When showing the IR reflectance spectra of the heat-treated samples, only data in the range 900-1200 cm⁻¹ will be shown as no changes occur at lower wavenumbers. This is consistent with previous studies as the position and intensity of a peak at 480 cm⁻¹ vary little with glass composition.

FIG. 3A shows spectra of the 6 wtFe glass heated at T_{g} for different durations in H₂/N₂ (10/90), and FIG. 3B shows spectra of the 6 wtFe glass heated for 2 hours at different temperatures in H₂/N₂ (10/90). For the untreated 6 wtFe glass, the FT-IR reflectance spectrum displays major peaks near 480 cm⁻¹ and 1100 cm⁻¹ that are assigned to Si—O—Si bond rocking and Si—O—Si antisymmetric stretching vibration, respectively. With increasing heat-treatment duration (FIG. 3A) and temperature (FIG. 3B), the following spectral features are observed. First, the peak at 1100 cm⁻¹ shifts towards lower wavenumbers and its intensity decreases. Second, the formation and growth of a peak at 940 cm⁻¹ is observed. Third, the formation and growth of a low-intensity peak near 970 cm⁻¹ is observed. The evolution of the Si—O—Si antisymmetric stretching peak shows that the surface depletes in silica. This confirms corresponding SNMS results not shown here. The peak at 940 cm⁻¹ is assigned to the vibration of Si—OH which is in agreement with the FT-IR absorption spectroscopy results as OH groups are formed. The weak peak near 970 cm⁻¹ is assigned to the vibration of Si—N bonds.

FIG. 3C shows spectra of the 6 wtFe glass heated at T_{g} for different durations in H₂/N₂ (1/99), and FIG. 3D shows spectra of the 6 wtFe glass heated for 2 hours at different temperatures in H₂/N₂ (1/99). The peaks assigned to the vibration of Si—OH and Si—N bonds are also present in these IR spectra, but the intensities of the peaks are lower than those observed for glasses heated in H₂/N₂ (10/90). The

IR absorption measurements show that less OH groups are formed with decreasing hydrogen pressure. This explains the lower intensity of the Si—OH peaks. The Si—O—Si antisymmetric stretching wavenumber and peak intensity increase with increasing tₒ and Tₐ. These changes have previously been observed for silicate glasses when decreasing the total network modifier content of the surface [Deriano et al., 2004]. This is consistent with the SNMS results as a silica-rich surface layer is created.

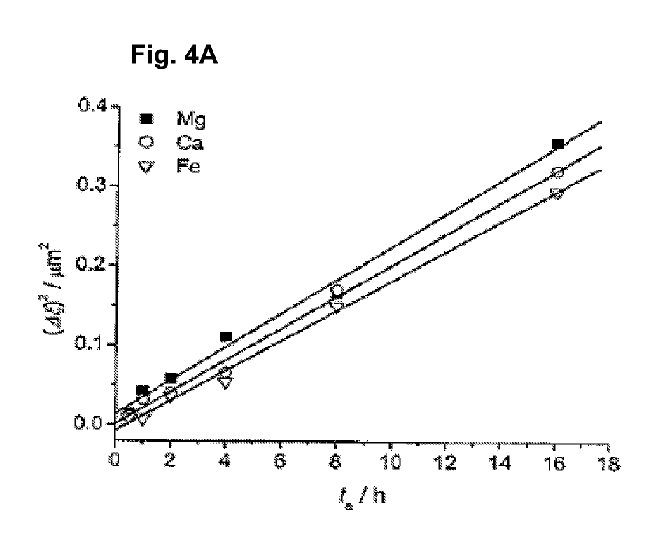

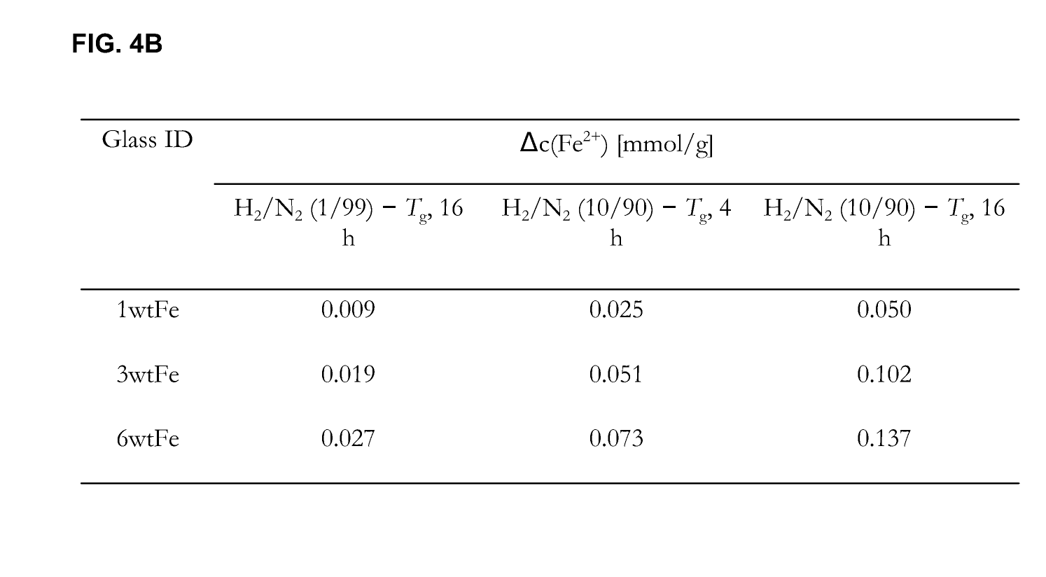

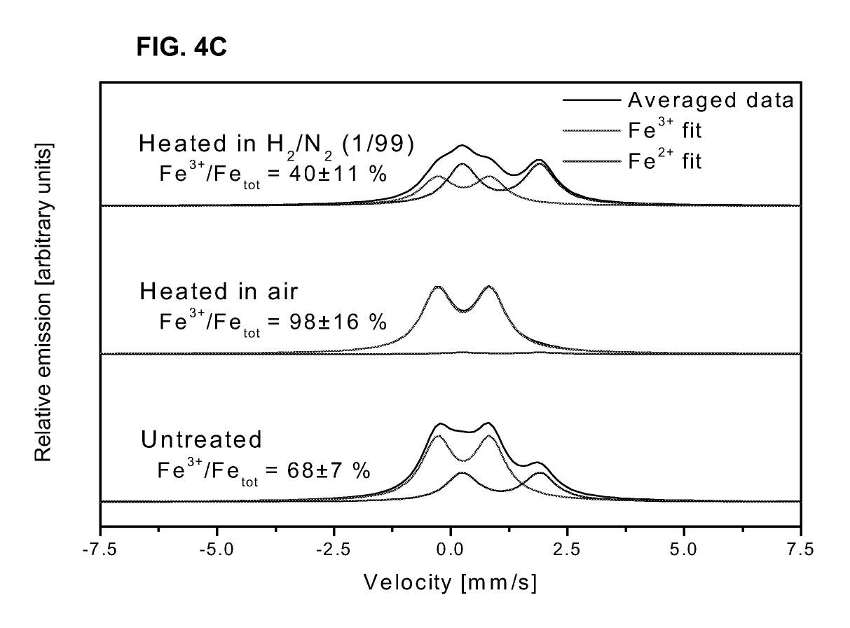

FIG. 4A shows a kinetic analysis by a plot of squared thickness of the of the modified surface region (Δξ) versus heat-treatment duration (tₐ) for the 6 wtFe glass samples in H₂/N₂ (1/99) at T_{g}. For the reduction mechanism presented in FIG. 1B to be valid, chemical diffusion of the divalent cations must rate-limit the reduction kinetics, i.e., the diffusion must be parabolic with time. Parabolic kinetics can be expressed in its integrated form as Δξ²=2k′t, where t is time and k′ is the parabolic reaction-rate constant. Hence, the linear relationships found in FIG. 4A prove that the kinetics signature is indeed parabolic, i.e., it is the diffusion of the network-modifying cations (NMC; e.g. Mg²⁺, Ca²⁺, and Fe²⁺) that is rate limiting for the dissipation of the free energy of the reduction reaction. Clear evidence for the earlier predicted mechanism (FIG. 1B) has been achieved. Mg²⁺ seems to be the fastest diffusing species which is in agreement with the higher field strength of Mg²⁺ compared to Ca²⁺ and Fe²⁺.

FIG. 4B shows a table describing the dependence of the difference in the Fe²⁺ concentration, before and after treatment (Δc(Fe²⁺)), on the initial iron-content of the glass and the heat-treatment condition. The untreated glasses contain more Fe³⁺ ions with increasing total iron content. As expected, FIG. 4B reveals that Δc(Fe²⁺) increases with increasing total iron content of the glass.

FIG. 4C shows conversion electron Mössbauer spectroscopy (CEMS) spectra of 6 wtFe glasses (untreated, heated in air at T_{g} for 16 h, and heated in H₂/N₂ (1/99) at T_{g} for 16 h), the fitted doublets of Fe³⁺ and Fe²⁺ are shown. CEMS can be used to study the iron redox state in the surface region (˜200 nm) of a sample, i.e., it is different from conventional Mössbauer spectroscopy that determines the redox state in the bulk. In conventional Mössbauer spectroscopy, the absorption peaks of the resonantly absorbed gamma rays are recorded. In CEMS, the energy released from the excited (metastable) iron nuclei in the sample is studied. The excited iron nuclei in the sample return to their ground state by three processes. Approximately 90% of the absorbed energy is released by so-called internal conversion and approximately 10% is released as gamma rays. The internal conversion includes transfer of the energy via X-rays or to so-called conversion electrons. The conversion electrons are emitted because the excited nucleus can transfer its energy to an electron that has a certain probability of being in the nucleus. In CEMS, the conversion electrons emitted from the excited nuclei are recorded. These electrons are strongly attenuated when they pass through the sample, i.e., the signals only come from the uppermost layer (approximately 200 nm) of the sample.

The isomer shifts of Fe³⁺ and Fe²⁺ are determined to 0.27±0.06 and 1.07±0.09 mm/s, respectively. The quadrupole splittings are 1.13±0.09 and 1.7±0.2 mm/s for Fe³⁺ and Fe²⁺, respectively. These values are in good agreement with literature data. The Fe³⁺/Feₜₒₜ ratio is estimated for each sample by measuring the relative areas of the two doublets and assuming that no metallic iron is present in the glasses. The calculated ratios are stated in FIG. 4C. The relatively high errors of the ratios are due to i) the use of a weak source and ii) the small surface areas of the samples. Fe³⁺/Feₜₒₜ equals 68±7% for the untreated 6 wtFe glass. This is consistent with the result found by conventional Mössbauer spectroscopy that determined the redox ratio of a powdered sample. As expected, heat-treatment of the glass in air results in an increased amount of Fe³⁺ ions compared to the amount of Fe²⁺ ions near the surface, whereas the opposite is valid for treatment in H₂/N₂ (1/99).

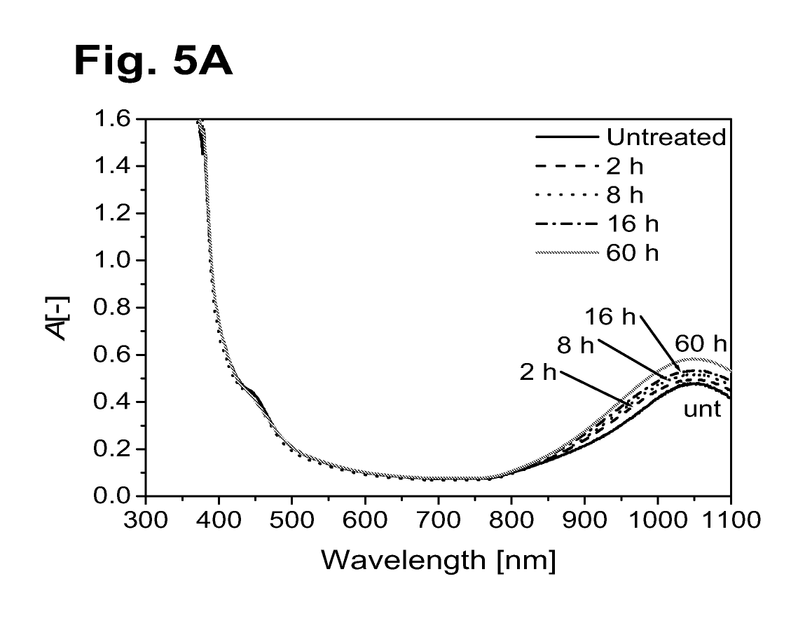

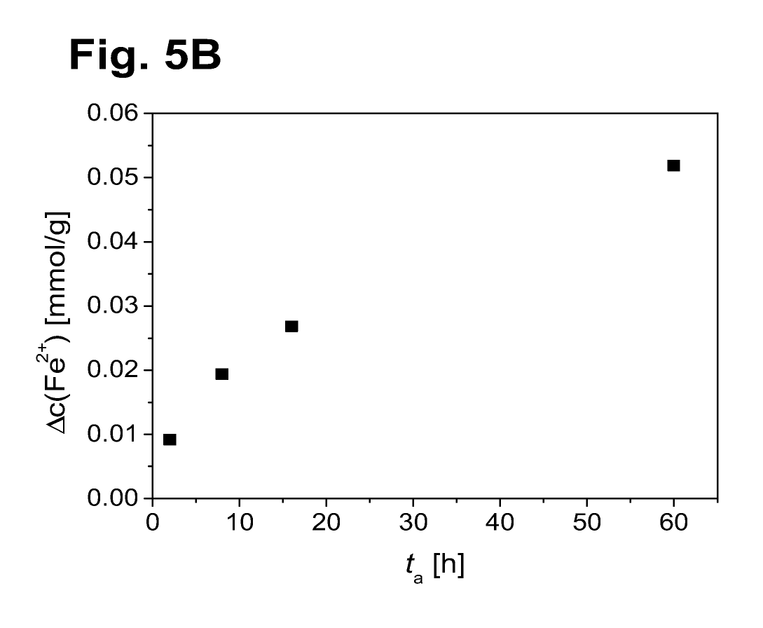

FIG. 5A shows UV-VIS-NIR spectra of 0.20 mm thick 6 wtFe glass samples heated in H₂/N₂ (1/99) at T_{g} for different durations. The iron redox state is investigated as a function of the different heat-treatment conditions. UV-VIS-NIR spec-troscopy is the main method used for that purpose. To use this method quantitatively, the molar absorption coefficient of Fe²⁺ is preliminarily determined.

FIG. 5B shows the corresponding Fe²⁺ concentrations expressed as the dependence of the difference in the Fe²⁺ concentration before and after treatment (Δc(Fe²⁺)) on the heat-treatment duration (tₐ). The increase in the intensity of the Fe²⁺ peak with increasing tₐ is less than the observed increase for glasses heated in H₂/N₂ (10/90) (not shown). Hence, the iron redox ratio is shifted to the more reduced state with increasing hydrogen partial pressure in the treatment atmosphere. This is explained by the increased solubility of H₂ (S_{H2}) in the glass at higher pressures.

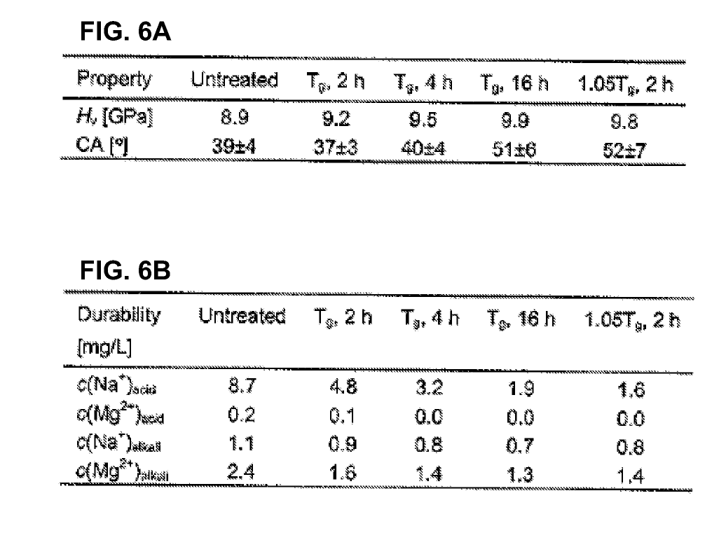

FIG. 6A shows a table with data of Vickers hardness (Hᵥ) and water contact angle of the untreated and thermally treated 6 wtFe glasses at different temperatures and durations. The Vickers hardness is measured by microindentation. 25 indentations were performed for each sample at widely separately locations with a load of 0.25 N and a hold time at the maximum load of 5 s. The Vickers hardness measurements reveal that the heat-treated glasses are harder than the original glass. The hardness increases with duration and temperature of the heat-treatment, i.e., the hardness increases when the thickness of the modified layer increases. The contact angle measurements show that the surface becomes more hydrophobic as a result of the thermal treatments. Hardness measurements were done with accuracies better than ±0.3 GPa.

FIG. 6B shows a table with data of chemical durability of the untreated and thermally treated (in H₂/N₂ (1/99)) 6 wtFe glasses at different temperatures and durations. The chemical resistance of the samples was examined in 0.25 M HCl and 0.25 M KOH solutions. After immersing a sample in plastic container with the test solution (20 cm³ for 1 cm² of the glass surface area), the container was mounted on a thermostatic shaking assembly at 90° C. (agitated at 100 rpm). After 12 h, the sample was removed from the solution. The concentrations of leached Na⁺ and Mg²⁺ ions were measured in the test solution using atomic absorption spectroscopy (AAnalyst 100, Perkin Elmer). The dissolution of the glasses was tested in both acid and alkali solutions. In acidic solutions, primarily the monovalent alkali ions leave the glass and are replaced by H⁺ and/or H₃O⁺. In alkali solutions, the liquid directly attacks the network bonds as hydroxyl ions can break the Si-0 bonds leading to the formation of silanolgroups and hence, a continuous dissolution of the glass. The thermally treated glasses possess a higher resistance towards both acid and alkali solutions than the untreated glass (cf. FIG. 6B). The increase in alkali resistance is caused by the high network connectivity of the treated glasses. The network modifying cations NMC occupy interstitial positions within the network creating nonbridging oxygens (NBO). The connected network on the surface of the treated glasses makes it difficult for ions to diffuse through the glass, impeding ions such as OH⁻ and H⁺ to penetrate the network and react with the glass species. Hence, OH⁻ diffusion is difficult in the thermally treated glasses increasing their alkali resistance. The increase in acid resistance is caused by the impeded diffusion of H⁺ and to a minor extent the depletion of sodium near the surface in the treated samples.

In summary, it is possible to create a glass surface enriched in silica by reducing a polyvalent element present in the glass. The hardness and chemical durability of the glasses are increased as a result of the surface modification resulting from the combined heating and reduction according to the present invention. This cheap and effective surface modification method can be used to strengthen any oxide glass containing network modifying cations (NMC) that can be reduced, e.g. having transition metals, i.e., glasses possessing properties approaching those of SiO₂ can be created without the requirement to melt the glass at the high temperatures normally required for silica-rich glasses.

In the investigated range of Tₐ and tₐ, a change of Tₐ or tₐ can preferably be used to change the extent of the surface modification. The heat-treatment atmosphere determines primarily how the surface is modified in terms of composition, morphology, and/or redox state. The effects of the heat-treatment atmosphere on the investigated glass properties are summarized in Table 2 below:

TABLE 2
The change in the investigated glass properties
as a function of the heat-treatment atmosphere for the
6wtFe glasses treated at T_{g} for 16 h.

| | | | H₂/N₂ | H₂/N₂ |
|---|---|---|---|---|
| Property | Air | N₂ | (10/90) | (1/99) |
| Stability against | 0 | 0 | −− | − |
| crystallization | | | | |
| Hardness | + | 0 | −− | ++ |
| Crack resistance | 0 | − | −− | ++ |
| Surface hydrophobicity | ++ | ++ | −− | ++ |
| Resistance in acid | ++ | ++ | ++ | ++ |
| solution | | | | |
| Resistance in alkali | −− | −− | −− | ++ |
| solution | | | | |

++: property increases by more than 5%;
+: property increases by less than 5%;
0: property is unchanged (or within the error range);
−: property decreases by less than 5%;
−−: property decreases by more than 5%.
All changes are in proportion to the untreated 6wtFe glass.

Table 2 may be used to select the appropriate surface modification method in order to achieve some desired properties. For most applications of glasses, the effects of treatment in H₂/N₂ (1/99) are the most favourable.

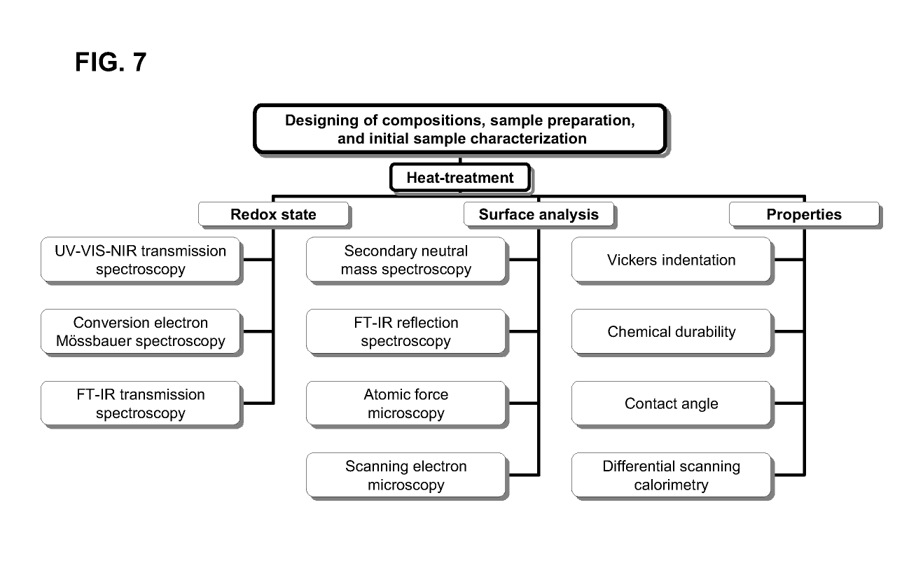

FIG. 7 shows a schematic overview of the experimental strategy and the employed analytical techniques.

### EXAMPLES

### Impact of Alkali Ions on Formation of SiO₂-Rich Surface Layer

The role of alkali ions in the inward cationic diffusion process is elucidated by answering the following questions:
What is the impact of the alkali ion on the diffusivity of alkaline earth ions?
Why are the alkali ions slower than the alkaline earth ions?
Which alkali ion most effectively creates the SiO2-rich surface layer?

To answer these questions, we perform three types of diffusion experiments.

First, glasses in the SiO₂—CaO—Fe₂O₃-A₂O (A=Na, K, Rb, Cs) series are heat-treated in the reducing H2/N2 (1/99 v/v) atmosphere for a given duration at various temperatures to determine the activation energy of Ca2+ diffusion as a function of the type of the alkali ion.

Second, heat-treatments are performed at short durations in order to study the initial phases of the diffusion process.

Third, glasses with and without alkali and alkaline earth ions, respectively, are compared in terms of their diffusion profiles. We also investigate the effect of the alkali ions on the reduction reactions, density, glass transition temperature, and fragility of the iron-bearing silicate glasses.

These results are used to gain insight into the observed diffusion phenomena.

We find that under these conditions the Ca²⁺ ions diffuse faster than alkali ions and that the presence of alkali ions decreases the diffusivity of Ca²⁺. In the SiO₂⁻ CaO—Fe₂O₃-A₂O (A=Na, K, Rb, or Cs) glass series, the activation energy of the Ca²⁺ diffusion decreases with alkali size in the sequence Na⁺, K⁺, Rb⁺, and Cs⁺. This trend is coincidence with a decrease of liquid fragility.

Sample Preparation. Six glasses (see Table 3) were prepared from analytical reagent-grade SiO₂, CaCO₃, Na₂CO₃, K₂CO₃, Rb₂CO₃, Cs₂CO₃, and Fe₂O₃ powders. The batches were mixed and melted at 1500° C. in an electric furnace (SF6/17, Entech) for 3 h in a Pt₉₀Rh₁₀ crucible. Afterwards, the glass melt was quenched on a brass plate and pressed to obtain cylindrical glasses of 7-10 cm diameter and ˜5 mm height. The prepared glasses were annealed ˜10 K above their respective glass transition temperatures for 10 min and then cooled naturally down to room temperature. It was also attempted to prepare a lithium-containing glass in the SiO₂—CaO—Fe₂O₃-A₂O series, but it was not possible due to phase separation.

TABLE 3
Chemical Composition, Radius r_{A} of the Alkali Ions, Density, Molar Volume, Glass
Transition Temperature T_{g}, and Fragility Index m of the Prepared Glasses^{a}

| | | | | | | | | Molar | | |
|---|---|---|---|---|---|---|---|---|---|---|
| | | Chemical comp. (mol %) | | | | r_{A} | Density | volume | T_{g} | m |
| Glass | A | SiO₂ | CaO | Fe₂O₃^{b} | A₂O | (Å) | (g/cm³) | (cm³/mol) | (K) | (—) |
| Si—Ca—Fe—Na | Na | 67.8 | 23.3 | 1.0 | 7.6 | 1.02 | 2.569 | 23.47 | 892 | 41.5 ± 0.2 |
| Si—Ca—Fe—K | K | 68.3 | 22.9 | 1.0 | 7.8 | 1.38 | 2.565 | 24.49 | 962 | 37.1 ± 0.8 |
| Si—Ca—Fe—Rb | Rb | 67.9 | 22.8 | 1.0 | 8.0 | 1.52 | 2.768 | 25.41 | 989 | 35.3 ± 0.4 |
| Si—Ca—Fe—Cs | Cs | 67.7 | 23.2 | 1.0 | 7.9 | 1.67 | 3.011 | 25.81 | 1013 | 34.5 ± 0.8 |
| Si—Ca—Fe | — | 62.6 | 36.2 | 1.1 | — | — | 2.672 | 22.38 | 1007 | n.d.^{c} |
| Si—Na—Fe | Na | 91.8 | — | 1.0 | 7.0 | 1.02 | 2.263 | 27.08 | 890 | n.d. |

^{a}r_{A} is stated for a coordination number of 6.⁸ T_{g} and m have been determined by DSC and viscosity measurements, respectively.
^{b}All iron is reported as Fe₂O₃.
^{c}n.d.: not determined.

Cylindrical glass samples (diameter ˜8-10 mm; thickness 3 mm) were prepared. The samples for the diffusion experiments were ground flat on one surface to a thickness of ˜2 mm by a six-step procedure with SiC paper under ethanol. The surfaces were carefully polished afterwards with 3 μm diamond paste and finally cleaned with acetone. To study the reduction reactions, ultraviolet-visible-near-infrared (UV-VIS-NIR) spectroscopy measurements were performed. The samples for these experiments were ground coplanar to achieve uniform thickness, and then they were polished to a thickness of 0.2 mm using the above-mentioned procedure.

Sample Characterization. The chemical compositions of the glasses are listed in Table 3. They were analyzed by x-ray fluorescence (XRF) on a S4-Pioneer spectrometer (Bruker-AXS). The main impurity in the glasses was Al₂O₃ (˜0.2 mol %). Densities of the glasses were measured by He-pycnometry (Porotech) and are also shown in Table 3.

The glass transition temperature (T_{g}) was measured using a differential scanning calorimetry (DSC) instrument (STA 449C Jupiter, Netzsch). The isobaric heat capacity (Cₚ) curve for each measurement was calculated relative to the Cₚ curve of a sapphire reference material after subtraction of a correction run with empty crucibles. Measurements were carried out in a purged Ar atmosphere. The following heating procedure was carried out to determine T_{g}. First, the sample was heated at 10 K/min to a temperature ˜1.11 times the respective T_{g} (in K) of each sample. Subsequently, the sample was cooled to room temperature at 10 K/min. Then, T_{g} was determined by a second upscan at 10 K/min in order to ensure a uniform thermal history of the glasses. T_{g} was defined as the cross point between the extrapolated straight line of the glass Cₚ curve before the transition zone and the tangent at the inflection point of the sharp rise curve of Cₚ in the transition zone.

Viscosity was measured by beam-bending (T>T_{g}) and concentric cylinder (T>T_{liquidus}) experiments. For beam-bending experiments, bars of 45 mm length and 3×5 mm² cross-section were cut from the bulk glasses. The bars were bent in a symmetric 3-point forced bending mode with 40 mm open span (VIS 401, Bähr). A 300 g weight was used to explore the viscosity range from approximately 1012 to 10^{9.5} Pa·s at a constant heating rate of 10 K/min. The viscosity was calculated according to DIN ISO 7884-4. The low viscosities (<10³ Pa·s) were measured using a concentric cylinder viscometer. The viscometer consisted of furnace, viscometer head, spindle, and sample crucible. The viscometer head (Physica Rheolab MC1, Paar Physica) was mounted on top of a high temperature furnace (HT 7, Scandiaovnen A/S). Spindle and crucible were made of Pt₈₀Rh₂₀. The viscometer was calibrated using the National Bureau of Standards (NBS) 710A standard glass.

Thermal Treatment. To induce the reduction reactions and diffusion processes, the polished glasses were heat-treated at 1 atm in an electric furnace under a flow of H₂/N₂ (1/99 v/v) gas. The glass samples were inserted into the cold furnace and the gas-flow was turned on. The furnace was then heated at 10 K/min to the pre-determined heat-treatment temperature and kept at this temperature for a given duration. Afterwards, the furnace was cooled down to room temperature at 10 K/min.

The glasses in the SiO₂—CaO—Fe₂O₃-A₂O (A=Na, K, Rb, Cs) series were treated at 0.95, 1.00, 1.025, and 1.05 times their respective T_{g} (in K) for 2 h, at their respective T_{g} for 60 h, and at the T_{g} (892 K) of the Si—Ca—Fe—Na glass for 60 h. Additionally, the Si—Ca—Fe—Na glass was treated at its T_{g} for 0.2, 1, 8, and 16 h, respectively. The ternary Si—Ca—Fe and Si—Na—Fe glasses were treated at their respective T_{g} for 2 h.

UV-VIS-NIR Spectroscopy. Usually, iron in glasses exists in the states of Fe²⁺ and Fe³⁺. In this work, UV-VIS-NIR absorption spectroscopy was used to determine the change in the valence state of iron of 0.20 mm thick samples for the SiO₂—CaO—Fe₂O₃-A₂O (A=Na, K, Rb, Cs) series. UV-VIS-NIR spectra were recorded over the wavelength range of 300 to 1100 nm using a UV-VIS-NIR Specord 200 spectrophotometer (Analytik Jena AG) at a resolution of 1 nm. The spectra were recorded with air as reference.

The ferrous (Fe²⁺) ion has a broad absorption peak with maximum absorbance at 1050-1100 nm. The position and maximum absorbance of this peak varies with glass composition and the absorption coefficients for our glasses were not known. Therefore, the absorption coefficient of the Lambert-Beer equation for the Si—Ca—Fe—Na glass was calculated: A=c·ε·x, where A is absorbance, c the concentration, £ the absorption coefficient, and x the sample thickness. In another study, the redox state [Fe³⁺]/[Feₜₒₜ], where [Feₜₒₜ]=[Fe²⁺]+[Fe³⁺], of this glass was found by Mössbauer spectroscopy to be 77±2 at %. By using the [Fe³⁺]/[Feₜₒₜ] ratio and the total iron content, the concentration of ferrous iron was calculated in the untreated Si—Ca—Fe—Na glass. Plotting the absorbance near 1075 nm versus the sample thickness (0.12, 0.20, 0.40, and 0.80 mm) gave a linear relation (R²=0.995). From the slope of this plot (c·ε), the absorption coefficient was calculated to be 3.82 L mol⁻¹ mm⁻¹.

Secondary Neutral Mass Spectroscopy. To investigate the diffusion processes, compositional analysis of the surfaces was carried out using electron-gas secondary neutral mass spectroscopy (SNMS). The measurements were performed on an INA3 (Leybold AG) instrument equipped with a Balzers QMH511 quadrupole mass spectrometer and a Photonics SEM XP1600/14 amplifier. The analyzed area had a diameter of 5 mm and was sputtered using Kr plasma with an energy of ˜500 eV. The time dependence of the sputter profiles was converted into depth dependence by measuring the depth of the sputtered crater at 12 different directions on the same sample with a Tencor P1 profilometer.

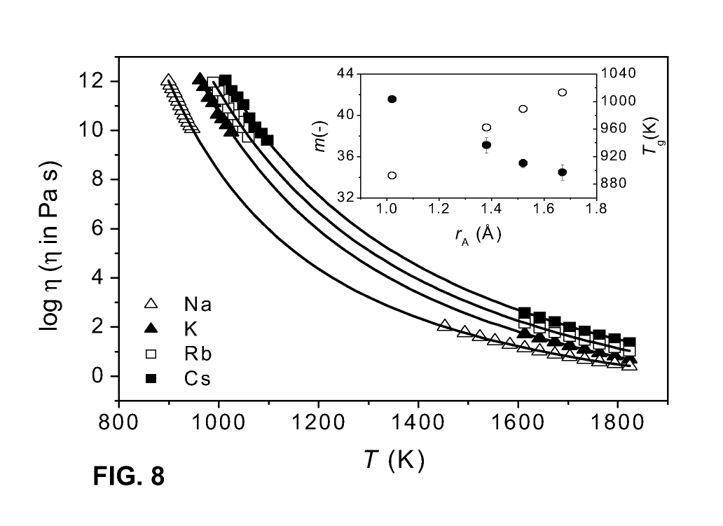

Results. FIG. 8 show a dependence of viscosity η on temperature T for the SiO₂—CaO—Fe₂O₃-A₂O glasses with A=Na, K, Rb, Cs. An increase in viscosity with increasing ionic radius r_{A} of the alkali ion at a given temperature is observed for both the low and high temperature data. To determine the liquid fragility index, we fit the viscosity data with the Mauro-Yue-Ellison-Gupta-Allan (MYEGA) equation,

$$log η = log {η}_{∞} + ( 12 - log {η}_{∞} ) \frac{{T}_{g}}{T} exp [ ( \frac{m}{12 - log {η}_{∞}} - 1 ) ( \frac{{T}_{g}}{T} - 1 ) ] ,$$

where η_{∞}, T_{g}, and m are fitting parameters. η_{∞} is the viscosity at infinite temperature and m is the fragility index of the glass-forming liquid. The fragility index is defined as the slope of the log η versus T_{g}/T curve at T_{g}:

$${m ≡ \frac{d log η}{d ( {T}_{g} / T )} \vert}_{T = {T}_{g}} .$$

In the model, the viscosity at T_{g} is set equal to 10¹² Pa·s since this has been shown to be equivalent to the calorimetrically measured T_{g} values for oxide glasses. The MYEGA equation offers improved accuracy in performing low temperature extrapolations compared to the Vogel-Fulcher-Tammann (VFT) and Avramov-Milchev (AM) equations. We apply the above equation in fitting the viscosity data. The fitting is done using a Levenberg-Marquardt algorithm. The fitted values of m are shown in the inset of FIG. 8 as a function of r_{A}. For the glass melts in the series SiO₂—CaO—Fe₂O₃-A₂O with A=Na, K, Rb, Cs, the fragility decreases with increasing size of the alkali ion. In contrast, the glass transition temperature increases with r_{A}.

UV-VIS-NIR spectra of untreated and heat-treated glasses in the SiO₂—CaO—Fe₂O₃-A₂O (A=Na, K, Rb, Cs) series are not shown. However, a maximum absorption peak is found at approximately 1075 nm, which is due to the presence of Fe²⁺ ions. The maximum absorbance and position of the Fe²⁺ peak is the same (within ±5%) for all glasses. This indicates that the initial [Fe³⁺]/[Feₜₒₜ] ratio is approximately the same in all the glasses. This has been additionally confirmed by performing thermogravimetric measurements on the glasses. The mass increase due to incorporation of oxygen was the same (within ±6%) for all six glasses. By using Mössbauer spectroscopy, we have found that the untreated Si—Ca—Fe—Na glass contains 77±2% of its Fe ions as Fe³⁺. To study the kinetics of the reduction reaction, the Si—Ca—Fe—Na glass has been heat-treated at its T_{g} of 892 K for 2, 8, 16, and 60 h. With increasing treatment duration tₐ, the absorbance of the Fe²⁺ band increases because Fe³⁺ is reduced to Fe²⁺. The change in Fe²⁺ concentration increases approximately linearly with the square root of the treatment duration, implying that diffusion-controlled kinetics occurs. UV-VIS-NIR spectra of the SiO₂—CaO—Fe₂O₃-A₂O (A=Na, K, Rb, Cs) glasses heat-treated at their respective T_{g} for 60 hours and at the T_{g} of the Si—Ca—Fe—Na glass (892 K) for 60 hours are not shown. When the glasses are treated at the same temperature the change in absorbance of the Fe²⁺ peak increases with increasing radius of the alkali ion. When the glasses are treated at their respective T_{g}, the trend is qualitatively the same but the differences between the glasses are more pronounced. This is because the Si—Ca—Fe—Cs glass has the highest T_{g} and therefore it is treated at the highest temperature.

The SNMS technique has been employed to study the reduction-induced diffusion processes in the six glasses. The method provides information about the surface composition of the glass as a function of depth. Depth profiles are not shown. However, it is found that the depth profile of the Si—Ca—Fe—K glass that has been heat-treated in H₂/N₂ (1/99) for 2 h at 1.05T_{g}=1010 K. A depletion of calcium, potassium, and iron is observed near the surface. The extent of the calcium depletion is larger than that of potassium and iron. Qualitatively all six glasses display the same type of surface depletion of network-modifying cations as a result of heat-treatment for 2 h at temperatures around their respective T_{g}. The surface depletion is caused by an inward diffusion of these ions induced by the reduction of Fe³⁺ to Fe²⁺. An important consequence of the inward diffusion is the creation of a silica-rich surface layer. Before heat-treatment in H₂/N₂ (1/99), the glasses do not show any variation in composition as a function of depth. To study the initial phases of the diffusion process, the Si—Ca—Fe—Na glass has been heat-treated at its T_{g} for 1 hour and 0.2 hours. The glass treated for 0.2 h displays an about 50 nm layer depleted in calcium and iron, whereas the concentrations of silicon and sodium are higher in this layer than in the bulk. When the duration of the treatment is increased to 1 h, the thickness of the layer depleted in calcium and iron increases and inward diffusion of sodium occurs. Furthermore, an enrichment of sodium is observed in the depth interval from approximately 50 to 100 nm. The ternary Si—Ca—Fe and Si—Na—Fe glasses have been heat-treated at their respective T_{g} for 2 h. Inward diffusion of Ca²⁺ and Na⁺, respectively, is also observed in these glasses.

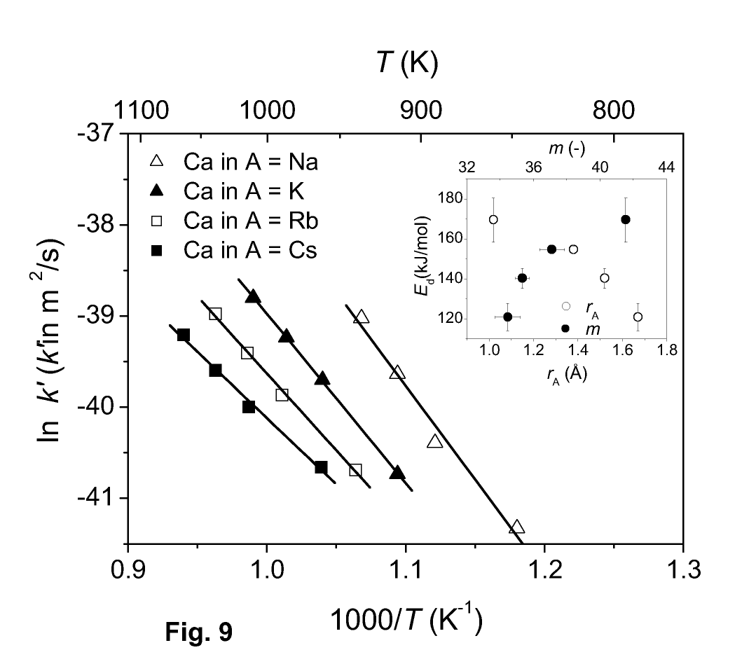

For the SiO₂—CaO—Fe₂O₃-A₂O (A=Na, K, Rb, Cs) glass series, the temperature dependence of the calcium diffusion has been systematically investigated. To quantitatively analyze the effect of the alkali ion on the diffusion of Ca²⁺, the diffusion depth (Δξ) of Ca²⁺ is calculated as the first depth at which c/c_{bulk} 1 for three measurements in succession. The inward cationic diffusion of alkaline earth ions is parabolic with time, thus we calculate the rate constant k′ of the calcium diffusion:

$${k}^{′} = \frac{{( Δ ξ )}^{2}}{{t}_{d}} ,$$

where t_{d} is the diffusion time (2 h). k′ is proportional to the product of the diffusion coefficient of the rate-limiting species (divalent cation) and a thermodynamic driving force (gradient in oxygen activity). Hence, from the temperature sensitivity of k′, the activation energy of calcium diffusion (E_{d}) can be obtained by plotting the data in Arrhenius coordinates (FIG. 9). The diffusion data for each glass reveal an Arrhenius dependence on temperature in the studied temperature range. E_{d} is calculated from the slope of each line and is plotted as a function of the ionic radius of the alkali ion. E_{d} decreases with increasing size of the alkali ion.

Effect of Alkali Ion on Redox-Diffusion Processes. When the glasses in the SiO₂—CaO—Fe₂O₃-A₂O (A=Na, K, Rb, Cs) series are heat-treated at the T_{g} of the Si—Ca—Fe—Na glass (i.e., at the same temperature), the order of the degree of reduction follows the same trend as that of the molar volume of these glasses (Table 3). Since the modifier ions are believed to occupy interstitial sites in the network, they block the paths for the small H₂ molecules. Hence, when the glass structure is relatively open, it is easier for the H₂ molecules to permeate the glass. In comparison, the diffusion data show that the isothermal inward diffusion of Ca²⁺ is fastest in the Si—Ca—Fe—Na glass, i.e., in the glass with the lowest molar volume. This is because two simultaneous processes contribute to the reduction of Fe³⁺ to Fe²⁺: H₂ permeation and outward flux of electron holes. The former process dominates the reduction reaction at 0.01 bar of H₂. Therefore, the thickness of modified surface layer (as measured by SNMS) cannot be directly correlated with the degree of reduction (as measured by UV-VIS-NIR spectroscopy). In other words, a large extent of Fe³⁺ reduction does not necessarily result in a thick SiO₂-rich surface layer because two processes contribute to the reduction of Fe³⁺.

There must therefore be another reason for why large alkali ions cause the slowest isothermal Ca²⁺ diffusion in the glasses. The Si—Ca—Fe—Cs glass has the highest T_{g} of the glasses and it has been shown that this type of redox-induced diffusion begins at temperatures around 0.8T_{g} (in K). Apparently, the process requires some degree of viscous softening even though the motion of the alkaline earth ions is decoupled from that of the network. Therefore, the glass with lowest T_{g} will have the fastest Ca²⁺ diffusion when the glasses are heat-treated at the same temperature.

The temperature sensitivity of the Ca²⁺ diffusion shows that the diffusion activation energy (E_{d}) decreases with increasing r_{A}. In another study, we predicted the presence of interconnected channels in the glass network based on the modified random network (MRN) model of Greaves. We found that the alkaline earth diffusion can be enhanced by lowering the liquid fragility due to the more simple diffusion paths in strong systems. This could also explain the results in this study since there is a positive correlation between E_{d} and m in the SiO₂—CaO—Fe₂O₃-A₂O (A=Na, K, Rb, Cs) series.

Regarding the inward diffusion, the results obtained in this study clearly demonstrate that alkali ions diffuse slower than the divalent calcium ions. In the beginning of the process, the alkali ions have not started to diffuse to any significant extent and the diffusion of Ca²⁺ and Fe²⁺ completely dominates. The high concentration of sodium in the surface layer of these glasses is caused by the inward diffusion of calcium and iron. The Ca²⁺ diffusion is faster than that of Na⁺ since the extent of Ca²⁺ diffusion in the Si—Ca—Fe—Na glass is larger than that of Na⁺ in the ternary Si—Na—Fe glass. The two glasses are comparable since they have approximately the same T_{g}. Furthermore, the presence of alkali ions decreases the diffusivity of the alkaline earth ions because the extent of Ca²⁺ diffusion is smaller in the Si—Ca—Fe—Cs glass than in the ternary Si—Ca—Fe glass. These two glasses also have approximately the same T_{g}. The presence of relatively slow alkali ions may therefore block the diffusion of the faster alkaline earth ions in the interconnected channels, i.e., the slow alkali ions occupy interstices and hereby increase the packing density. These interstices can no longer be used for alkaline earth migration.

The reason for why the alkaline earth ions are faster than the alkali ions must be that the divalent alkaline earth ions are the most suitable ones for carrying the positive charge that charge-balance the outward flux of electron holes. An alkaline earth ion neutralizes two electron holes, whereas an alkali ion neutralizes only one electron hole. In addition, the alkaline earth ions are more mobile than trivalent modifier ions (e.g., Al³⁺) because the latter ones are more strongly bound to the oxygen anions. The diffusion coefficient of the alkali ions is smaller in the inward diffusion process compared to what is found in the literature because the latter results have predominantly been obtained by the use of a radioactive tracer.

Conclusions. We have studied the impact of alkali ions on the diffusion of calcium ions in the glass transition range in iron-bearing silicate glasses. The diffusion is induced by thermally treating the glasses in a reducing atmosphere at temperatures around T_{g}. This treatment causes a reduction of Fe³⁺ to Fe²⁺, which requires an inward diffusion of mobile cations. We have found that the mobility of Ca²⁺ strongly depends on the type of the alkali ion present in the glass and that the diffusion of Ca²⁺ is faster than that of the alkali ions. The presence of alkali ions decreases the mobility of Ca²⁺ and the activation energy of Ca²⁺ diffusion decreases with increasing radius of the alkali ion. The latter trend is coincidence with a decrease of liquid fragility and an increase of glass transition temperature.

### Impact of Polyvalent Element on Formation of SiO2-Rich Surface Layer

In this work, seven different polyvalent elements (Fe, Mn, Cu, Ce, Ti, V, and Cr) are examined in terms of their impact on the formation of the silica-rich surface layers. This is done in order to understand the mechanism of the internal diffusion and to broaden and optimizing the application of the methods. As a result of this work, it can be found out which element is the most suitable ingredient of the glass for obtaining the crystalline oxide layer and the silica-rich layer, respectively.

Seven soda-lime silicate glasses, each of which contains one of the following polyvalent metals: Fe, Mn, Cu, Ce, Ti, V, and Cr, are oxidized in air and reduced in H₂/N₂ (1/99) at their respective glass transition temperatures for some period. A crystalline oxide surface layer is created on the glasses (except the vanadium-bearing glass) under the oxidizing condition, since the metallic ions are oxidized from lower to higher valence state, and thereby calcium ions diffuse outward and react with oxygen ions. In contrast, a silica-rich surface layer is created on the glasses under the reducing condition, since sodium and calcium ions diffuse inward. It is found that the extent of both outward and inward diffusions strongly depends on the type of the polyvalent ions for the same conditions of heat-treatment. Out of the seven polyvalent metals studied in this work, copper induces the highest extent of both the inward and outward diffusion, and hence, the thickest surface layer of both amorphous silica and crystalline alkaline earth oxides. The oxide layer lowers the onset temperature of the primary crystallization. The silica-rich surface layer enhances the chemical resistance of the glass in a hot basic solution.

Sample preparation. Seven glasses were prepared from three main analytical reagent-grade chemicals (SiO₂, Na₂CO₃, and CaCO₃) and one minor analytical reagent-grade polyvalent metal oxide (Cr₂O₃, MnO₂, CeO₂, V₂O₅, CuO, Fe₂O₃, or TiO₂). The batch materials were melted in a Pt₉₀Rh₁₀ crucible in an electric furnace (SF6/17, Entech) at 1500° C. for 3 h. The melt was then cast onto a brass plate and pressed to obtain cylindrical glasses of 7-10 cm diameter and ˜5 mm height. The prepared glasses were immediately annealed at 640° C. for 10 min and then cooled naturally down to room temperature in the closed furnace. The chemical compositions of the glasses were analyzed by x-ray fluorescence (S4-Pioneer, Bruker-AXS) and are listed in Table 4. The main impurity was Al₂O₃ (<0.1 mol %).

TABLE 4
Chemical composition and glass transition temperature (T_{g}) of the
prepared glasses containing various polyvalent oxides (AₓO_{y}).

| | |
|---|---|
| Polyvalent | Chemical composition (mol %) |

| oxide | SiO₂ | Na₂O | CaO | AₓO_{y} | T_{g} (° C.) |
|---|---|---|---|---|---|
| TiO₂ | 65.6 | 8.7 | 23.7 | 1.9 | 636 |
| V₂O₅ | 68.1 | 7.8 | 23.1 | 0.9 | 630 |
| Fe₂O₃ | 67.8 | 7.6 | 23.3 | 1.0 | 619 |
| CuO | 66.5 | 7.8 | 23.5 | 2.0 | 621 |
| Cr₂O₃ | 67.2 | 8.0 | 22.6 | 2.1 | 633 |
| CeO₂ | 67.3 | 7.9 | 22.8 | 2.0 | 635 |
| MnO₂ | 66.6 | 8.1 | 23.0 | 2.1 | 621 |

Thermal analyses. The glass transition temperature (T_{g}) was measured using differential scanning calorimetry (DSC). The DSC measurements were performed on a simultaneous thermal analyser (STA) (449C Jupiter, Netzsch). All the glasses were subjected to two runs of up- and downscans at 10° C./min. The onset temperature of the endothermic Cₚ (isobaric heat capacity) jump during the second upscan was assigned as T_{g}.

The STA instrument was also used for recording both DSC and thermogravimetric (TG) signals during both iso-thermal (i.e, constant temperature) and dynamic (i.e., increasing temperature at constant heating rate) heating, from which the oxidation degree of the polyvalent ions were determined. The measurements were performed on powdered samples by crushing and sieving the glass samples. The 45-63 μm size fraction was collected for each glass. A platinum crucible containing the glass sample and an empty platinum crucible were placed on the sample carrier of the STA at room temperature. To evaporate water from the samples, the crucibles were initially heated at a rate of 10° C./min to 300° C. and held for 15 min before cooling down to room temperature. For iso-thermal heating experiments, both crucibles were then held 5 min at an initial temperature of 60° C. and heated at a rate of 10° C./min to the respective T_{g} of the glasses and held at this temperature for 6 or 12 h. For dynamic heating experiments, the crucibles were also held 5 min at an initial temperature of 60° C. but were then heated at a rate of 10° C./min to 975° C. After both types of heating schedules had ended, the crucibles were cooled down to 250° C. at a rate of 10° C./min, and finally down to room temperature at a natural rate. Atmospheric air dried by a molecular sieve was used as purge gas.

Determination of redox states of polyvalent elements. By using a ultraviolet-visible-near-infrared (UV-VIS-NIR) Specord 200 spectrophotometer (Analytik Jena AG) at a resolution of 1 nm, UV-VIS-NIR spectra were recorded over the wavelength range of 300-1100 nm. The measurements were performed on 2.0 mm thick samples ground by a six-step procedure with SiC paper, followed by polishing with 3 μm diamond suspension. The UV-VIS-NIR spectra were used to qualitatively determine the redox states of the polyvalent elements present in the untreated glasses.

Post-treatment and characterizations. The bulk glasses were cut in cylinders of 10 mm diameter and 2-3 mm height. One surface of each sample was then ground by a six-step procedure with SiC paper, followed by polishing with 3 μm diamond suspension. To induce the inward cationic diffusion, the polished glasses were heat-treated at 1 atm in an electric furnace under a flow of H₂/N₂ (1/99 v/v) gas. The glass samples were inserted into the cold furnace and the gas-flow was turned on. The furnace was then heated at 10° C./min to the respective T_{g} of the glasses and kept at this temperature for 6 h. The diffusion process was ended by cooling the furnace to room temperature at 10° C./min. To induce the outward cationic diffusion, the polished glasses were heat-treated by applying an identical heating procedure under atmospheric conditions.

The diffusion profiles were determined by electron-gas secondary neutral mass spectroscopy (SNMS). SNMS is used to determine the elemental concentrations as a function of the depth within the glass. The measurements were performed by using an INA3 (Leybold AG) instrument equipped with a Balzers QMH511 quadrupole mass spectrometer and a Photonics SEM XP1600/14 amplifier. The analyzed area had a diameter of 5 mm and was sputtered using Kr plasma with an energy of ˜500 eV. The time dependence of the sputter profiles was converted into depth dependence by measuring the depth of the crater at 12 different locations on the same sample with a Tencor P1 profilometer.

Chemical durability test. The chemical durability of both untreated and heat-treated samples was measured in a hot basic solution to see the impact of the internal diffusion on glass properties. The chemical durability of the samples was examined in 0.25 M KOH solution (pH=13.2). After immersing a sample in a plastic container with the test solution (20 cm³ for 1 cm² of the glass surface area), the container was mounted on a thermostatic shaking assembly at 90° C. (agitated at 100 rpm). After 6 h, the sample was removed from the solution. The concentration of leached Ca²⁺ ions was measured in the test solution using atomic absorption spectroscopy (AAnalyst 100, Perkin Elmer).

Results and discussion. UV-VIS-NIR spectra was made (not shown) of the untreated Cr- and Ti-containing glasses. Cr can exist as Cr²⁺, Cr³⁺, and Cr⁶⁺ in silicate glasses. No absorption bands due to Cr²⁺ are observed, whereas both Cr³⁺ (at 445, 640, 660, and 690 nm) and Cr⁶⁺ (at 360 nm) are observed. Ti can exist as Ti⁴⁺ and Ti³⁺. Ti⁴⁺ has d⁰ electron configuration, in which only charge transfer transitions occur in the UV range. Hence, Ti⁴⁺ is colorless and no absorption bands can be observed in the spectrum. It has been reported that Ti³⁺ can have a single band centered at 570 nm, but this is not observed in this work. Fe and Mn can exist as Fe²⁺ and Fe³⁺ and Mn²⁺ and Mn³⁺, respectively. The di- and trivalent states are detected in both glasses. V can exist as V³⁺, V⁴⁺, and V⁵⁺, but only V⁴⁺ is detected. V⁵⁺ is expected to be present in silicate glasses melted in air, but its strong charge transfer bands are found in the UV-range, which causes a sharp UV-absorption edge. Cu can exist as Cu⁰, Cu⁺, and Cu²⁺, and Cu²⁺ is observed in the spectrum of the untreated glass, whereas Cu⁺ is colorless. Finally, Ce can exist as Ce³⁺ and Ce⁴⁺. Both redox states cause absorption peaks in the UV-range, and hence, they cannot be observed due to a sharp UV-absorption edge. Table 4 exhibits the chemical compositions and the T_{g} values of the seven glasses studied in this work. As expected, the glasses with the higher field strength polyvalent metal ions (Ti, Ce, Cr, V) have higher values of T_{g} than the rest. For example, Ti⁴⁺ is known to act as a network former and V⁵⁺ may serve to increase the polymerization degree of a silicate network.

To study the impact of the polyvalent element on the oxidation process and the crystallization behavior of the as-produced glasses, both DSC and TG measurements were carried out in air at a heating rate of 10° C./min on powdered samples. The energy response of the samples to the dynamic heating and the mass change of the glasses during the heating are measured using DSC and TG, respectively. An increase in mass of 0.20% at temperatures above 550° C. was observed. The increase in mass is caused by oxidation of Cr²⁺ to Cr³⁺ and/or Cr³⁺ to Cr⁶⁺. However, because Cr²⁺ is only present in very small amounts in silicate glasses prepared under oxidizing melting conditions, and it is not observed in the UV-VIS-NIR spectrum, the oxidation of Cr²⁺ to Cr³⁺ can be neglected. According to the oxidation mechanism of iron, the oxidation reaction causes the incorporation of oxygen into the glass by forming metallic surface oxides. The oxidation of Cr³⁺ to Cr⁶⁺ is connected with a weak exothermic peak in the DSC curve that has its maximum at ˜705° C. between the glass transition temperature (T_{g}=633° C.) and the onset temperature of crystallization (T_{c}=855° C.). The inflection point of the TG curve (not shown) corresponds to the maximum of the oxidation peak.

The TG traces of the seven glasses heated at 10° C./min in air are displayed in FIG. 10. All glasses display a mass increase similar to that of the Cr-containing glass, i.e., all the studied polyvalent elements have ions that can be oxidized. However, the extent of the mass increase differs between the glasses. To calculate the number of moles Δn of each polyvalent element that has been oxidized, the stoichiometry of the oxidation reaction must be known. According to Table 4, the following reactions take place when the Cr- and Mn-containing glasses are heated above T_{g}:

4Cr³⁺+3O₂—>4 Cr⁶⁺+6O²⁻

4 Mn²⁺+O₂—>4 Mn³⁺+2O²⁻

The stoichiometry of the second reaction is also valid for oxidation of Ti³⁺ to Ti⁴⁺, V⁴⁺ to V⁵⁺, Fe²⁺ to Fe³⁺, Cu⁺ to Cu²⁺, and Ce³⁺ to Ce⁴⁺. It is assumed that the mass increase of the samples during heating is solely due to incorporation of oxygen. Mössbauer spectroscopy experiments have confirmed this assumption for the oxidation of Fe²⁺ to Fe³⁺ during heating of iron-bearing aluminosilicate glass fibers in air. The normalized number of moles that has been oxidized (Δnᵣₑₗ) can then be calculated by the following equation:

$$Δ {n}_{rel} = \frac{x \cdot Δ m}{{m}_{0} \cdot {M}_{{O}_{2}}}$$

where m₀ is the initial mass of the sample, Δm is the maximum increase in mass, and M_{O}_{₂} is the molar mass of oxygen. x is the ratio between the number of moles of the polyvalent element being oxidized and the number of moles of O₂ being consumed in the oxidation process, i.e., x is 4/3 for oxidation of Cr³⁺ to Cr⁶⁺ and x is 4 for the other oxidation reactions. The values calculated using the equation for the dynamic heating procedure (Δn_{rel,dyn}) are listed in Table 5. Cu⁺ is oxidized to the largest extent, whereas very limited amounts of Ti³⁺ and V⁴⁺ are oxidized.

TABLE 5
Δnᵣₑₗ, ᵢₛₒ, Δn_{rel, dyn}, T_{c}, and Tₚ of the as-produced glasses.

| Polyvalent | Δn_{rel, iso} | Δn_{rel, dyn} | | |
|---|---|---|---|---|
| element | (μmol/g) | (μmol/g) | T_{c} (° C.) | Tₚ (° C.) |
| Ti | 8 | 10 | 888 | 915 |
| V | 5 | 15 | 893 | 922 |
| Fe | 66 | 93 | 871 | 892 |
| Cu | 80 | 105 | 820 | 841 |
| Cr | 63 | 83 | 855 | 890 |
| Ce | 41 | 62 | 884 | 907 |
| Mn | 59 | 84 | 869 | 888 |

Δn_{rel, iso} and Δn_{rel, dyn} are the normalized number of moles of the polyvalent element that were oxidized during iso-thermal heating in air at T_{g} for 6 h and during dynamic heating in air at 10° C./min to 975° C., respectively. The characteristic temperatures were determined from DSC measurements performed at an upscanning rate of 10° C./min in air.

Table 5 shows the T_{c} (onset temperature of crystallization) and Tₚ (peak temperature of crystallization) values of the glasses. In general, the crystallization begins at a lower temperature when a larger mass increase occurs, i.e., a higher degree of oxidation during the dynamic heating (FIG. 11). During the DSC upscanning in air, oxidation of the lower valence state ions takes place, which leads to formation of an oxide surface layer. By using x-ray diffraction (XRD), atomic force microscopy (AFM), and secondary neutral mass spectroscopy (SNMS), it has been proved that the oxide layer is nano-crystalline. The results obtained in this study indicate that the nano-crystalline layer lowers the activation energy for crystallization since the crystals can grow from the nuclei that are already formed at the surface. This agrees with the results of previous studies, in which it has been shown by DSC experiments that the crystallization starts at the surface when the nano-crystalline surface layer is present.

The mass increase during iso-thermal heating of the powdered samples in air at their respective T_{g} for 6 h was also measured by TG. In the inset of FIG. 10, the mass change of the Cr-containing glass is shown. The normalized number of moles oxidized during the iso-thermal heating procedure (Δn_{rel,iso}) is calculated using before mentioned equation and listed in Table 5. There is a positive correlative between Δn_{rel,iso} and Δn_{rel,dyn}, i.e., when a large degree of oxidation occurs as a result of the dynamic heating, it also occurs as a result of the iso-thermal heating.

To study the diffusion processes associated with the oxidation and reduction reactions, SNMS is used to determine the concentration depth profiles of the seven glasses that prior to the measurements have been oxidized in air or reduced in H₂/N₂ (1/99) at their respective T_{g} for 6 h. It should be noticed that the untreated glasses show no changes in composition as a function of depth. The normalized concentration depth profiles of Si, O, Ca, and Na of the Cu-containing glass oxidized in air are not shown. A high surface concentration of calcium is found, which is due to outward diffusion of Ca²⁺. The low surface concentration of sodium and silicon is due to the enrichment of calcium and oxygen near the surface. The concentration profiles of the Cu-containing glass as a result of heat-treatment in H₂/N₂ (1/99) are not shown. A depletion of sodium and calcium is found near the surface, which causes formation of the high silica concentration in the surface layer. The uncertainty in the detection of the polyvalent elements by SNMS is relatively high because of their low concentration. Therefore, it has not been possible to evaluate whether these elements have diffused as a result of the heat-treatments.

Outward and inward diffusion of Ca²⁺ occurs in all the glasses when they are heated in air and H₂/N₂ (1/99), respectively. The only exception is the V-containing glass, in which no outward diffusion is observed as a result of the heat-treatment in air. This must be due to the very limited oxidation of V⁴⁺ (Table 5). To quantitatively compare the degree of Ca²⁺ diffusion for the different glasses, the peak area (A_{Ca}) of the Ca²⁺ curve and the diffusion depth (D_{Ca}) of Ca²⁺ are calculated. The areas are calculated between the SNMS concentration curve of Ca²⁺ and the horizontal line through c=c_{bulk}·D_{Ca,ox} and D_{Ca,red} are calculated as the first depth at which c/c_{bulk}≦1 and c/c_{bulk}≦1, respectively, for three measurements in succession. The calculated values are listed in Table 6. A positive correlative between A and D is found.

TABLE 6
SNMS peak areas and diffusion depths of Ca²⁺ for the
seven glasses heat-treated under oxidizing (air) and reducing
(H₂/N₂ 1/99) atmospheres at their respective T_{g} for 6 h.

| Polyvalent | A_{Ca, ox} | D_{Ca, ox} | A_{Ca, red} | D_{Ca, red} |
|---|---|---|---|---|
| element | (nm) | (nm) | (nm) | (nm) |
| Ti | 0.7 | 81 | 3.1 | 93 |
| V | 0 | 0 | 7.8 | 249 |
| Fe | 2.3 | 220 | 10.5 | 264 |
| Cu | 5.4 | 307 | 13.1 | 315 |
| Cr | 2.4 | 235 | 7.1 | 202 |
| Ce | 1.7 | 153 | 4.6 | 173 |
| Mn | 2.1 | 209 | 2.6 | 83 |

The areas are calculated between the SNMS concentration curves of Ca²⁺ and the horizontal line through c = c_{bulk}.

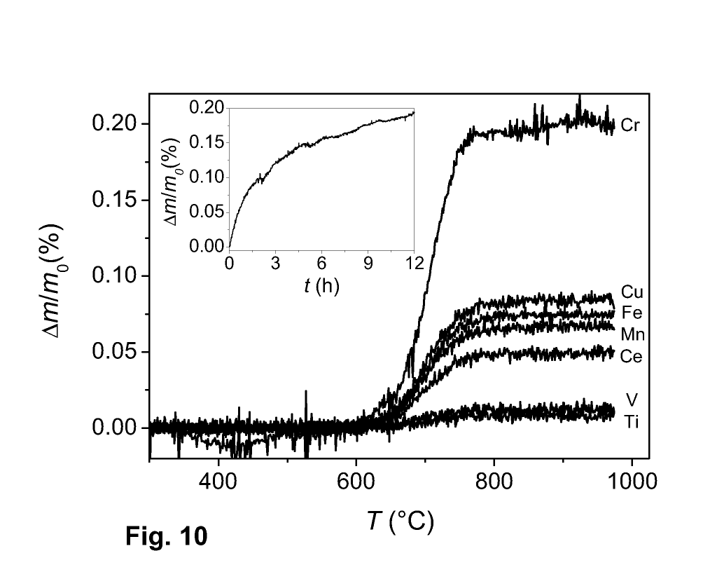

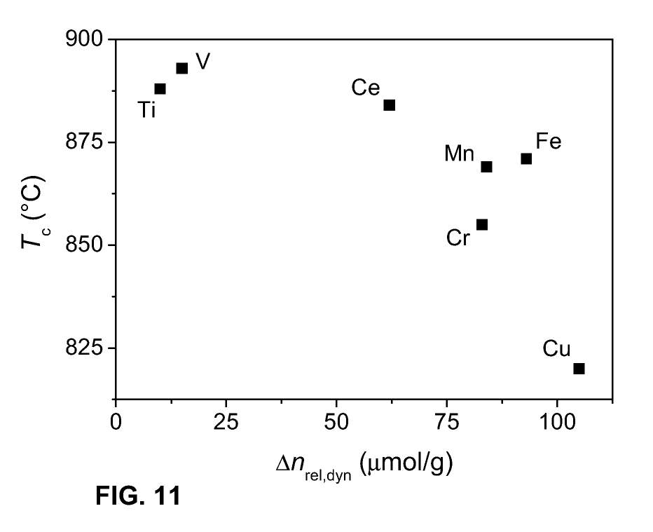

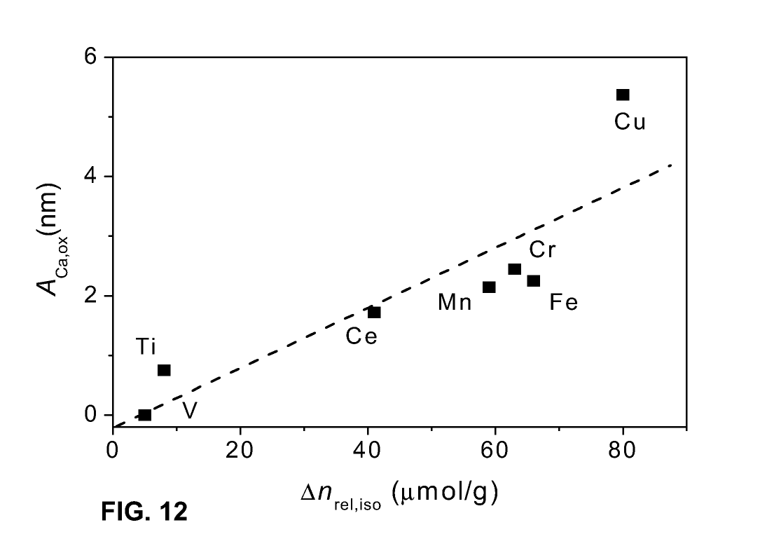

To study if the degree of oxidation of a given polyvalent element is linked with the degree of diffusion, A_{Ca,ox} is plotted as a function of Δn_{rel,iso} (FIG. 12). Both A_{Ca,ox} and Δn_{rel,iso} were obtained from the iso-thermal heating procedure, but it should be noticed that A_{Ca,ox} was determined by using a bulk sample, whereas Δn_{rel,iso} was determined by using a powdered sample. If the mass changes were obtained by using bulk samples, the mass increase would have been below the detection limit of the apparatus due to the small surface area. FIG. 12 shows that the degree of Ca²⁺ diffusion increases approximately linearly with increasing degree of oxidation of the polyvalent element. This clearly demonstrates that the outward diffusion is driven by the oxidation of the polyvalent element. A similar tendency is expected between the degree of inward diffusion and the degree of reduction of the polyvalent element. However, this has not been possible to investigate because the TG measurements could not be conducted in the reducing H₂/N₂ atmosphere due to use of platinum crucibles and sample holder.

Based on the results represented in Table 6, it is concluded that Cu is the element for creating the thickest layers under the same heat-treatment conditions. The elements that are either highly reduced or oxidized before the heat-treatments create the thinnest modified surface layers. This could be explained as follows. For example, if an element is fully reduced before heat-treatment in H₂/N₂ (1/99), the concentration of ions that may be reduced is low, and hence, the created layer will be thin. On the other hand, if the element is almost fully oxidized, the concentration of reducible ions is high, but the reduction reaction is thermodynamically unfavorable, which will also result in a thin layer.

The impact of the surface modifications on the glass properties is investigated by determining the chemical durability of both untreated and heat-treated glasses in 0.25 M KOH solution (pH=13.2). The concentrations of Ca²⁺ in the leaching solutions after 6 h at 90° C. are given in Table 7.

TABLE 7
Chemical durability of the as-produced glasses and the glasses heat-
treated in air and H₂/N₂ (1/99) at their respective T_{g} for 6 h.

| Polyvalent | c(Ca²⁺)ᵤₙₜ | c(Ca²⁺)ₒₓ | c(Ca²⁺)_{red} |
|---|---|---|---|
| element | (mg/L) | (mg/L) | (mg/L) |
| Ti | 2.5 | 2.6 | 2.3 |
| V | 2.6 | 2.5 | 1.8 |
| Fe | 2.6 | 2.9 | 1.6 |
| Cu | 2.5 | 3.1 | 1.4 |
| Cr | 2.6 | 2.6 | 1.8 |
| Ce | 2.6 | 2.7 | 2.0 |
| Mn | 2.7 | 2.8 | 2.2 |

Chemical durability is expressed by the leached amount of Ca²⁺ (c(Ca²⁺)) ions after 6 h in 0.25M KOH solution at 90° C. Concentration measurements were done with accuracies better than ±0.2 mg/L.

During the leaching experiment, the hydroxyl ions directly attack the Si—O network bonds, resulting in the formation of silanol groups (—Si—OH):

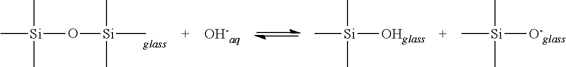

A continuous dissolution of the glass from the surface is the result of this process. The untreated glasses do not have significantly different chemical durabilities. Some of the glasses that have been oxidized in air display a lower resistance towards the basic solution than the corresponding untreated glasses. This is explained by the low surface concentration of silicon because few Si—O bonds need to be broken in order to dissolve a relatively large amount of Ca²⁺ ions. The increase in basic resistance of the glasses reduced in H₂/N₂ (1/99) is caused by the high network connectivity of the treated glasses due to the inward diffusion of Ca²⁺. It seems that for both samples heated in air and H₂/N₂ (1/99), the chemical durability depends on the thickness of the modified surface layer.

Conclusions. Oxidation and reduction of seven polyvalent elements in silicate glasses result in diffusion processes near the surface. The oxidation process leads to formation of a crystalline oxide surface layer, whereas the reduction process leads to formation of a silica-rich layer. The crystalline surface layer lowers the onset temperature of the primary crystallization process, whereas the silica-rich surface layer enhances the chemical resistance of the glass in a hot basic solution. The diffusion mechanisms of modifying ions appear to be universal for all polyvalent element-containing glasses at temperatures around T_{g}. To create the thickest modified surface layer, the polyvalent element must be present in the glass as a mixture of oxidized and reduced ions. Of the studied elements, Cu is the optimal ingredient for formation of the thickest surface layers under the same redox treatment condition.

### Impact of Alkaline Earth Ions on Formation of SiO2-Rich Surface Layer

Here, we investigate the influence of the type of the alkaline earth ion on the inward diffusion process in the SiO₂—Na₂O—Fe₂O₃—RO (R═Mg, Ca, Sr, Ba) glass series. We also attempt to find out whether and how the inward cationic diffusion is correlated with the viscous flow behaviour of glasses in the glass transition range, i.e., with the liquid fragility. The latter is a generally accepted concept that describes the extent of the non-Arrhenius flow. The liquid fragility is related to the glass composition and structure and the glass structure strongly influences the energy barrier of the diffusion of electron holes and modifying ions. In the present work, both a kinetic fragility index m (i.e., steepness of the log viscosity vs. T_{g}/T curve at T_{g}) and a thermodynamic index Cₚₗ/C_{pg} (i.e., the ratio of the liquid to the glassy isobaric heat capacity at T_{g}) are determined as measures of liquid fragility. Finally, we also study the influence of the alkaline earth ion on the redox state of iron using Mössbauer spectroscopy because the inward cationic diffusion process is affected by the initial Fe³⁺ concentration.

We have studied the correlation between liquid fragility and the inward diffusion (from surface towards interior) of alkaline earth ions in the SiO₂—Na₂O—Fe₂O₃—RO (R═Mg, Ca, Sr, Ba) glass series. The inward diffusion is caused by reduction of Fe³⁺ to Fe²⁺ under a flow of H₂/N₂ (1/99 v/v) gas at temperatures around the glass transition temperature (T_{g}). The consequence of such diffusion is the formation of a silica-rich nanolayer. During the reduction process, the extent of diffusion (depth) decreases in the sequence Mg²⁺, Ca²⁺, Sr²⁺ and Ba²⁺, whereas the fragility increases in the same sequence. It is found that the ratio of the activation energy of the inward diffusion E_{d} near T_{g} to the activation energy for viscous flow E_{η} at T_{g} increases with increasing fragility of the liquid. The inward cationic diffusion can be enhanced by lowering the fragility of glass systems via varying the chemical composition.

Sample preparation. Four iron-bearing alkali-alkaline-earth silicate glasses (see Table 8) were prepared from analytical reagent-grade SiO₂, Na₂CO₃, MgO, CaCO₃, SrCO₃, BaCO₃, and Fe₂O₃ powders. The mixed batch materials were melted in an electrical furnace (SF6/17, Entech) at 1500° C. in a Pt₉₀Rh₁₀ crucible for 3 h. The melt was then cast onto a brass plate and pressed to obtain cylindrical glasses of 7-10 cm diameter and ˜5 mm height. The prepared glasses were annealed 10 K above their respective glass transition temperatures for 10 min and then cooled down to room temperature within 20 h.

TABLE 8
Chemical composition, density, molar volume (=molar mass/density),
and iron redox ratio of the prepared glasses. The radii r of the
alkaline earth ions are stated for a coordination number of 6.

| | Chemical | | | | | Molar | Fe³⁺/ | |
|---|---|---|---|---|---|---|---|---|
| | composition (mol %) | | | | Density | volume | Feₜₒₜ | r |
| R | SiO₂ | Na₂O | Fe₂O₃* | RO | (g/cm³) | (cm³/mol) | (at %) | (Å) |
| Mg | 69.0 | 7.7 | 1.1 | 21.7 | 2.475 | 20.772 | 74 ± 2 | 0.72 |
| Ca | 67.8 | 7.6 | 1.0 | 23.3 | 2.569 | 23.469 | 77 ± 2 | 1.00 |
| Sr | 68.6 | 7.7 | 1.0 | 22.4 | 3.022 | 23.498 | 80 ± 5 | 1.18 |
| Ba | 66.8 | 8.1 | 1.0 | 23.2 | 3.295 | 25.212 | 74 ± 2 | 1.35 |

*All iron reported as Fe₂O₃

Sample characterization. The chemical compositions of the glasses were analyzed by X-ray fluorescence (S4-Pioneer, Bruker-AXS) and are listed in Table 8. The main impurity was Al₂O₃ (˜0.2 mol %). Densities of the glasses were measured by He-pycnometry (Porotech) and are also given in Table 8. Transmission ⁵⁷Fe Mössbauer spectroscopy on powdered samples was employed to study the effect of the alkaline earth ion on the redox state of the Fe ions. A constant acceleration spectrometer with a source of ⁵⁷Co in rhodium was used and calibrated with α-Fe. Measurements were made at room temperature and data were collected for one week for each sample. Isomer shifts are given relative to that of the calibration spectrum.

The glass transition temperature (T_{g}) was measured using a differential scanning calorimetry (DSC) instrument (STA 449C Jupiter, Netzsch). The Cₚ curve for each measurement was calculated relative to the Cₚ curve of a sapphire reference material after subtraction of a correction run with empty crucibles. Measurements were carried out in a purged Ar atmosphere. The following heating procedure was carried out to determine T_{g}. First, the sample was heated at 10 K/min to a temperature 1.11 times the respective T_{g} (in K) of each sample. Subsequently, the sample was cooled to room temperature at 10 K/min. Then, T_{g} was determined by a second upscan at 10 K/min in order to ensure a uniform thermal history of the four glasses. The ratio Cₚₗ/C_{pg} was also determined from this scan. To determine the liquid fragility, the viscosity was measured by beam-bending (T>T_{g}) and concentric cylinder (T>T_{liquidus}) experiments. For beam-bending experiments, bars of 45 mm length and 3×5 mm² cross-section were cut from the bulk glasses. The bars were blended in a symmetric 3 point forced bending mode with 40 mm open span (VIS 401, Bähr). A 300 g weight was used to explore the viscosity range from approximately 10¹² to 10¹⁰ Pa·s at a constant heating rate of 10 K/min. The viscosity was calculated according to DIN ISO 7884-4. The low viscosities (<10² Pa·s) were measured using a concentric cylinder viscometer. The viscometer consisted of four parts: furnace, viscometer head, spindle, and sample crucible. The viscometer head (Physica Rheolab MC1, Paar Physica) was mounted on top of a high temperature furnace (HT 7, Scandiaovnen A/S). Spindle and crucible were made of Pt₈₀Rh₂₀. The viscometer was calibrated using the National Bureau of Standards (NBS) 710A standard glass.

Diffusion experiments. As diffusion depths below 1 μm are expected based on the above studies, the sample surfaces were carefully prepared. First, the bulk glasses were cut in cylinders of 10 mm diameter and 2-3 mm height. One surface of each sample was then ground by a six-step procedure with SIC paper, followed by polishing with 1 μm diamond suspension.

To induce the inward cationic diffusion, the polished glasses were heat-treated at 1 atm in an electrical furnace under a flow of H₂/N₂ (1/99 v/v) gas. The presence of oxygen in the furnace is not completely avoidable. But it is possible to keep its partial pressure at a known value by using a Fe₃O₄/Fe₂O₃ redox buffer. Fe₂O₃ and Fe₃O₄ powders were mixed in the molar ratio 3:2 and placed inside the furnace together with the samples. The glass samples and redox buffer were inserted into the cold furnace and the gas-flow was turned on. The furnace was then heated at 10 K/min to the pre-determined heat-treatment temperature Tₐ and kept at this temperature for the duration tₐ. The diffusion process was ended by cooling the furnace to room temperature at 10 K/min. The glasses were treated at 0.95, 1.00, 1.025, and 1.05 times their respective T_{g} (in K) for 2 h and at their T_{g} for 16 h. In addition, the Mg-containing glass was treated at its T_{g} for 0.5 and 8 h. The diffusion profiles were determined by electron-gas secondary neutral mass spectroscopy (SNMS). SNMS is used to determine the elemental concentrations as a function of the depth within the glass. The measurements were performed by using an INA3 (Leybold AG) instrument equipped with a Balzers QMH511 quadrupole mass spectrometer and a Photonics SEM XP1600/14 amplifier. The analyzed area had a diameter of 5 mm and was sputtered using Kr plasma with an energy of ˜500 eV. The time dependence of the sputter profiles was converted into depth dependence by measuring the depth of the crater at 12 different locations on the same sample with a Tencor P1 profilometer.

Results. The transmission ⁵⁷Fe Mössbauer spectrum of the untreated Ca-containing glass at 295 K is not shown. The two doublets, seen in the spectrum, are due to paramagnetic Fe³⁺ (isomer shift of 0.28 mm/s and quadrupole splitting of 1.07 mm/s) and Fe²⁺ (isomer shift of 1.00 mm/s and quadrupole splitting of 1.86 mm/s). A sextet due to Fe³⁺ is also seen in the spectrum. It can be due to the presence of clusters that may have formed during quenching. The sextet and the two doublets appear in the Mössbauer spectra of all the four glasses, only the areas of the peaks vary. The relative spectral areas of Fe³⁺ (doublet and sextet) and Fe²⁺ (doublet) are used to calculate the Fe³⁺/Feₜₒₜ ratio for each of the untreated glasses (Table 8).

The isobaric heat capacity (Cₚ) curves recorded during DSC upscans for the four glass compositions are not shown. T_{g} is determined at the cross point between the extrapolated straight line of the glass Cₚ curve before the transition zone and the tangent at the inflection point of the sharp rise curve of Cₚ in the transition zone. The T_{g} values within an accuracy of ±3 K are given in Table 9. T_{g} is plotted as a function of the ionic radius of the alkaline earth ion (r) (not shown). The radii of the alkaline earth ions are listed in Table 8 for a coordination number of 6. T_{g} is found to decrease with increasing r.

TABLE 9
Characteristic parameters of the
SiO₂—Na₂O—Fe₂O₃—RO glasses with
R = Mg, Ca, Sr, Ba determined by
DSC and viscosity measurements.

| | T_{g} | | Cₚₗ − C_{pg} | | |
|---|---|---|---|---|---|
| R | (K) | Cₚₗ/C_{pg} | (J g⁻¹ K⁻¹) | F | m |
| Mg | 912 | 1.22 | 0.28 | 2.68 ± 0.02 | 35.7 ± 0.4 |
| Ca | 892 | 1.27 | 0.32 | 3.00 ± 0.05 | 39.4 ± 0.8 |
| Sr | 858 | 1.29 | 0.35 | 3.30 ± 0.09 | 42 ± 2 |
| Ba | 823 | 1.30 | 0.36 | 3.55 ± 0.07 | 45 ± 1 |

The errors of F and m are within the 95% confidence limits.

The viscosity data for the four compositions obtained from beam-bending and concentric cylinder viscometry are not shown. However, for both the low and high temperature data, a decrease in viscosity (n) with increasing r is observed. To describe the temperature dependence of viscosity of glass-forming liquids, we apply the Avramov-Milchev (AM) equation:

$$log η = A + {B ( \frac{{T}_{g}}{T} )}^{F}$$

where A, B, F, and T_{g} are constants, which are obtained by fitting the viscosity data to the equation. A is log η_{∞}, where η_{∞} is the viscosity at infinite temperature. F is the fragility index of the glass-forming liquid and it is a function of the chemical composition at ambient pressure. The higher the F value, the more fragile the liquid. Since the viscosity for oxide glasses at T_{g} is equal to 10¹² Pa·s, the equation may be simplified as the following expression:

$$log η = log {η}_{∞} + ( 12 - log {η}_{∞} ) {( \frac{{T}_{g }}{T} )}^{F} .$$

In this equation, there are only 3 parameters. The data are fitted with this modified AM equation by using the Levenberg-Marquardt algorithm. It is found that this equation fits the data better than both the Vogel-Fulcher-Tammann (VFT) equation and the Adam-Gibbs (AG) equation. The F values for the four compositions are given in Table 8. Fragility can also be described by the index m, which is defined as the slope of the log η versus T_{g}/T curve at T_{g}:

$${m = \frac{d log η}{d ( {T}_{g} / T )} \vert}_{{T}_{g}} .$$

F can be converted to m through the following relation:

m=(12−log η_{∞})F.

The calculated values of m are listed in Table 9. The studied glass melts become more fragile with increasing size of the alkaline earth ion. The fragility described here is the so-called kinetic fragility. Several attempts have been made to correlate the kinetic fragility with thermodynamic property changes at T_{g}. It has been suggested to use the ratio of the heat capacity of the liquid to that of the glass at T_{g} (Cₚₗ/C_{pg}) as a measure of thermodynamic fragility. We have calculated Cₚₗ/C_{pg} for the four compositions based on the DSC measurements and the values are stated in Table 9. Cₚ, is the offset value of the Cₚ overshoot above the glass transition range. To determine C_{pg}, a linear function is fitted to the Cₚ values at temperatures below T_{g}. The value of this function at T_{g} is reported as C_{pg}. The results in Table 9 show that Cₚₗ/C_{pg} increases with increasing r. For comparison, the step change in the heat capacity (Cₚₗ/C_{pg}) at the glass transition is also calculated and listed in Table 9. Similar tendencies for Cₚₗ/C_{pg} and Cₚₗ/C_{pg} are observed.

The diffusion profiles in the four glasses heat-treated under H₂/N₂ (1/99) at their respective T_{g} for 16 h are not shown. However, all glasses display a depletion of sodium, iron, and the respective alkaline earth ion near the surface. This inward diffusion causes the high surface concentration of silica. It should be noted that the untreated glasses show no changes in composition as a function of depth. To quantitatively analyze the data, the diffusion depths (Δξ) of the alkaline earth ions are determined for Tₐ=T_{g} (FIG. 12). Δξ is calculated as the first depth at which c/c_{bulk}≦1 for three measurements in succession. FIG. 12 shows that the order of the alkaline earth ion mobility at isokom temperatures is: Mg²⁺>Ca²⁺>Sr²⁺>Ba²⁺.

For the reduction mechanism to be valid, chemical diffusion of the alkaline earth ions must occur, i.e., the diffusion must be parabolic with time. Parabolic kinetics can be expressed in its integrated form as:

(Δξ)²=k′t,

where t is time and k′ is a constant. k′ is proportional to the product of the diffusion coefficient of the rate-limiting species and the normalized (to RT) thermodynamic driving force. A kinetic analysis is performed by plotting (Δξ)² against the duration of the heat-treatment (0.5, 2, 8, and 16 h) at Tₐ=T_{g} for the Mg-containing glass. A linear relationship is found with a coefficient of determination (R²) of 0.999 (see inset of FIG. 13). This proves that the kinetic signature is indeed parabolic.

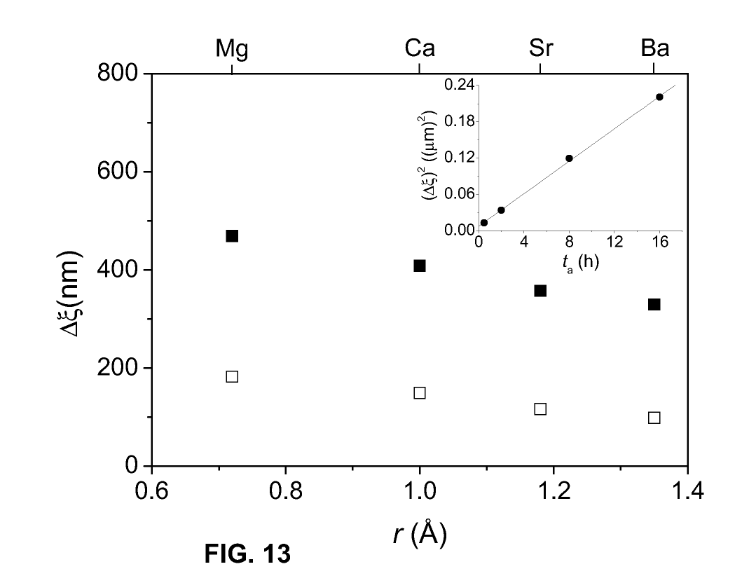

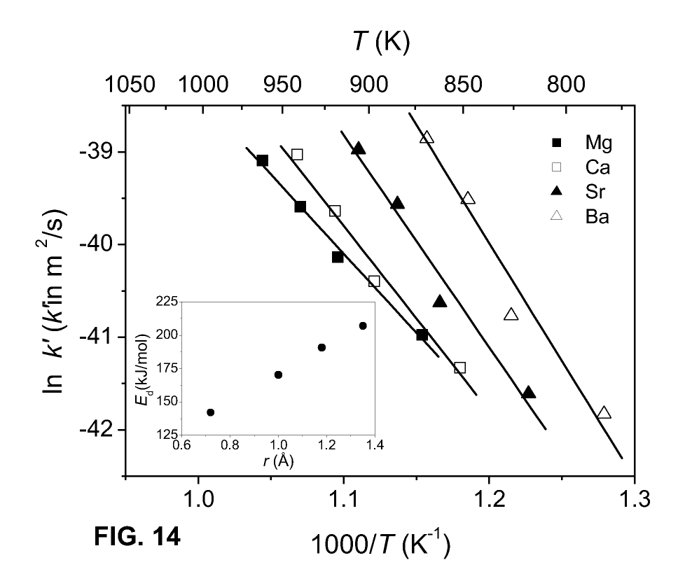

To study the temperature dependence of the alkaline earth diffusion, we calculate the temperature sensitivity of k′ from the change of Δξ with temperature at a constant diffusion time. FIG. 14 presents the resulting Arrhenius plots. The diffusion data for each glass reveal an Arrhenius dependence on temperature (see solid lines in FIG. 14). From the slope of each line, an activation energy of diffusion around T_{g} (E_{d}) is calculated and shown as a function of r in the inset of FIG. 14. E_{d} increases with increasing r, and hence, with decreasing field strength of the alkaline earth ions.

Since only the nature of the alkaline earth ion has been changed and not its concentration, the number of non-bridging oxygens (NBOs) is the same in all glasses when neglecting the small variations in the compositions of the glasses (Table 8). As it is known, variation of the fragility of silicate melts may result from small changes of hydroxyl content. However, differences in hydroxyl content are predominantly due to variations of the melting conditions, which are not modified for the silicate glasses of this study. Thus, we assume only marginal changes in hydroxyl concentration of the untreated glasses. In addition, the iron redox ratio does not differ between the samples when considering the error range of the data (see Table 8), which is in agreement with the findings in a previous study. Hence, the observed changes in T_{g}, fragility, and diffusion cannot be explained by the concentration of NBOs or Fe³⁺. The changes must be due to the difference in size of the alkaline earth ions (and hence, in their field strength), in ionic packing density, and bond angle distributions.

The increase in T_{g} with decreasing r of alkaline earth ions (R²⁺) is attributed to the strengthening of the overall network since a decrease of r also leads to an increase in their field strength, and hence, to an enhanced attraction of R²⁺ ions to their surrounding structural groups of [SiO₄] tetrahedra. The Mg²⁺ ions most strongly attract the nearby [SiO₄] tetrahedra, and hence, a higher potential energy barrier needs to be overcome to initiate glass transition. Similarly, the viscosity decreases at both high and low temperatures with increasing r. In accordance with the alkaline earth field strength also the molar volume of the glasses decreases in the sequence Ba>Sr>Ca>Mg, indicating a less open structure for high field strength cations (Table 8).

The kinetic fragility (quantified by F or m) shows a positive correlation with the thermodynamic fragility (quantified by Cₚₗ/C_{pg} or Cₚₗ/C_{pg}). However, it has been shown that this correlation is not generally true for small organic and polymeric liquids, whereas the correlation exists for inorganic glass-forming liquids. The fragility is found to increase with increasing r of the alkaline earth ions in the glass series studied in this work. This may be explained as follows. For a more fragile liquid, there is a larger change in the structure of the liquid with temperature than for a less fragile liquid. The high field strength of Mg²⁺ causes a high degree of short range order, which prevents the structure from a rapid break-down with increasing temperature.

Our diffusion experiments have shown that the Mg²⁺ ions are the fastest at isokom temperatures and have the lowest E_{d}. It has previously been reported that alkaline earth ions are most mobile in alkali alkaline earth silicate glasses when the radii of the alkali and alkaline earth ions are similar. The jump of an alkaline earth ion from one octahedral site to another leaves behind a high negative charge density that induces an electric dipole moment. This moment might cause a backward jump of the alkaline earth ion. However, when the alkali and alkaline earth ions have similar radii, the highly mobile alkali ions can easily enter the alkaline earth ion sites and hereby reduce the probability of the backward jump. In our sodium alkaline earth silicate glasses, the Ca²⁺ ions should then be the fastest and have the lowest E_{d} as the radius of Na⁺ (1.02 Å) is very similar to that of Ca²⁺ (1.00 Å). In addition, the iron reduction causes the alkali ions to diffuse (role of Na⁺ in diffusion process is discussed later). These factors limit the ability of Na⁺ to jump into the empty alkaline earth ion sites, which might explain why Ca²⁺ is not found to be the fastest ion in our glasses.

According to the MRN model, the network modifying oxides form interconnected channels (i.e., a percolative network) at sufficiently high concentration. The threshold for percolation occurs at 16 vol % of modifying oxides, which is exceeded by the glass compositions studied in this work. The alkaline earth ions should diffuse fastest through the channels when their size is smallest which explains our diffusion results at isokom temperatures. The activation energy of diffusion is the sum of an electrostatic term due to the Coulomb interaction between the cation and the NBO plus an elastic part to open up doorways into neighboring sites. In our glasses, the latter term governs the activation energy as the smallest alkaline earth ion has the lowest E_{d} since it most easily moves through the channels. The channels are constituted by [SiO₄] tetrahedra, i.e., the required displacement of oxygen is relatively small for a small alkaline earth ion.

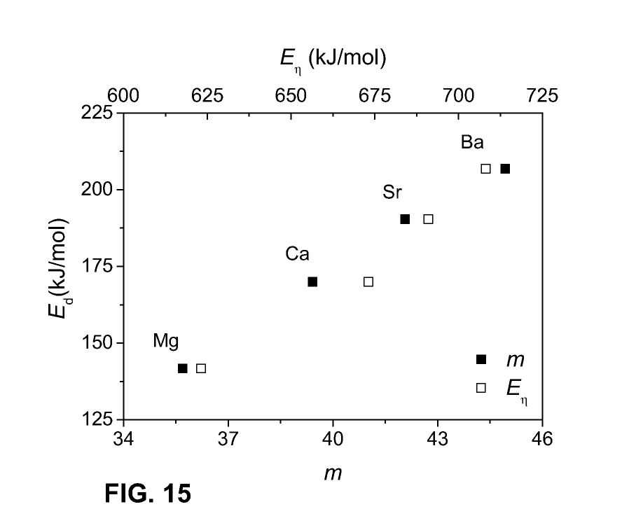

To study the link between ionic diffusion and fragility, E_{d} is plotted against m in FIG. 15. m is found to be proportional to E_{d}, implying that the diffusion of alkaline earth ions in glasses is related to the liquid fragility. This could be explained as follows. Strong glass systems have a smaller configurational entropy (S_{c}) than fragile glass systems. S_{c} is the part of the entropy of a pure liquid that is determined by the abundance of possible packing states obtainable at the temperature T. Therefore, fragility depends on the multiplicity of states (local potential energy minima), i.e., strong systems will have a structure with fewer accessible states than fragile systems. Alkali and alkaline earth ions should therefore diffuse faster in strong systems than in fragile systems due to the simple diffusion paths in the former ones.

To study if the diffusion of alkaline earth ions in glasses is linked to the viscous flow of the network, the following relation is considered:

E_{η}=mT_{g}R ln10=(12−log η_{∞})FT_{g}R ln10,

where E_{η} is the activation energy of viscous flow at T_{g} and R is the gas constant. E_{d} is plotted against E_{η} in FIG. 15 and a clear linear correlation is observed, but the E_{d}/E_{η} ratio is smaller than 1. According to the Stoke-Einstein equation, the activation energy of diffusion increases with increasing viscosity. However, the equation cannot be used to predict ion mobilities, because the ions use the transportation route with the lowest activation energy, i.e., they flow faster than the cooperative rearrangements of the structural units. In other words, the diffusion of alkali and alkaline earth ions is decoupled from the network change.

The role of Na⁺ in the diffusion processes appears to be complex. Even though alkali ions are normally considered to be the fastest ions in glasses, the diffusion depth of Na⁺ is generally smaller than that of the alkaline earth ions, which is in agreement with our previous studies. In addition, an enrichment peak of Na⁺ (compared to the surrounding Na⁺ concentration) is found near the surface of the heat-treated samples for R═Ca, Sr, and Ba, but not for R═Mg (not shown). The height and width of this peak decrease with decreasing Tₐ and tₐ. These results imply that Na⁺ diffuses back to the surface after its initial inward diffusion. This agrees with the existence of an interdiffusion mechanism of alkaline earth ions and sodium ions as suggested by the values of the decoupling ratios. These issues will be addresses in more detail in a future study by investigating the reduction induced diffusion in 68 SiO₂−23 CaO−8 R₂O (R═Na, K, Rb, Cs)−1 Fe₂O₃ glasses.

Other features of the inward cationic diffusion process are discussed in the following. The diffusion profiles (not shown) indicate that the diffusion of Ca²⁺, Sr²⁺, and Ba²⁺ occurs in different step, whereas this is not the case for Mg²⁺. For the Mg-containing glass, the change in concentration with depth is approximately linear. The inward diffusion of Ca²⁺, Sr²⁺, and Ba²⁺ might be slowed down at larger depths due to the accumulation of these relatively large ions. This would explain why the depth, at which the slope of the concentration versus depth curve suddenly changes, seems to decrease with increasing r.

The inward diffusion process is driven by reduction of Fe³⁺ to Fe²⁺, but Fe²⁺ is capable of diffusing itself. The ionic radius of Fe²⁺ in 6-fold coordination is 0.78 Å for the high spin state. The diffusion data of iron reveal two general features. First, the diffusion depth of Fe²⁺ decreases with increasing r. Second, the ratio between the diffusion depth of Fe²⁺ and that of the alkaline earth ion (Δξ_{Fe}/Δξ_{R}) decreases with increasing r (in average: 0.9 for R═Mg and 0.4 for R═Ba). These observations are explained by the steric hindrance induced by the larger alkaline earth ions on the diffusion of Fe²⁺.

Conclusions. By means of an inward diffusion process driven by reduction of iron, we have studied the diffusion of alkaline earth ions in the glass transition range in silicate glasses and the link to the liquid fragility. The fragility is found to increase with increasing ionic radius of the alkaline earth ion. The diffusion is studied by heat-treating the glasses at temperatures around T_{g} as this causes an inward diffusion of mobile cations due to reduction of Fe³⁺ to Fe²⁺. The determined activation energies of diffusion (E_{d}) reveal that the small alkaline earth ions are the most mobile and that E_{d} increases with increasing fragility. We have explained our results based on the modified random network model, which predicts the formation of percolation channels in the studied glasses. The small ions most easily move through these channels that are constituted by [SiO₄] tetrahedra. The results imply that the inward cationic diffusion can be enhanced by lowering the fragility of glass systems. In accordance with the diffusion mechanism, it is found that E_{d}<E_{η} as the alkaline earth ions bypass the slow cooperative rearrangements of the glass network by using the transportation path with the lowest activation energy. The inward cationic diffusion process can be used to create a silica-rich nanolayer on glass surfaces and the results obtained in this study show that Mg²⁺ ions most effectively creates this layer at isokom temperatures.

### Impact of Reducing Gas on Formation of SiO2-Rich Surface Layer

To examine whether a gas with larger reducing molecules than H₂ at a higher pressure in the atmosphere can be used to induce the formation of the silica-rich layer, we apply a CO/CO₂ (98/2 v/v) atmosphere as a reducing agent for heat-treatments at T_{g} of iron-bearing silicate glasses. Afterwards, we compare the concentration profile of the surface layer of the CO/CO₂ treated glass with that of the H₂/N₂ (1/99) treated glass. The information on the dependence of the creation of the silica-rich surface layer on the gas type and composition is important for clarifying the mechanism of the inward diffusion process and for the application of the surface modification technology.

We find that inward diffusion of network-modifying cations can occur in an iron-containing silicate glass when it is heat-treated in CO/CO₂ (98/2 v/v) or H₂/N₂ (1/99 v/v) gases at temperatures around the glass transition temperature. The inward diffusion is caused by the reduction of ferric to ferrous ions and this diffusion leads to formation of a silica-rich surface layer with a thickness of 200˜600 nm. The diffusion coefficients of the network-modifying divalent cations are calculated and they are different for the glasses treated in the CO and H₂ gases. At the applied partial pressures of CO and H₂, the H₂-bearing gas creates the silica-rich layer more effectively than the CO-bearing gas. The layer increases the hardness and chemical durability of the glass due to the silica network structure in the surface layer.

Experimental. Two glasses named 6 wtFe and 3 wtFe were prepared by melting mixtures of analytical reagent-grade raw materials at 1500° C. under atmospheric air. Composition of the 6 wtFe glass (in wt %) is 69.4 SiO₂, 10.8 CaO, 9.3 MgO, 4.4 Na₂O, and 6.1 Fe₂O₃, whereas that of 3 wtFe glass is 71.0 SiO₂, 11.1 CaO, 9.6 MgO, 4.5 Na₂O, and 3.2 Fe₂O₃. Here, all iron (Fe²⁺ and Fe³⁺) is reported as Fe₂O₃. NaO and CaO were introduced into the batch using their respective carbonates. SiO₂ was introduced as quartz, Fe₂O₃ as Fe₂O₃, and MgO as Mg(OH)₂.(MgCO₃)₄.(H₂O)₅. Conventional transmission ⁵⁷Fe Mössbauer spectroscopy measurements on powdered samples were used to determine the iron redox state of the untreated iron-containing glasses. A constant acceleration spectrometer with a source of ⁵⁷Co in rhodium was used. The spectrometer was calibrated using a foil of a—Fe at room temperature. The ratio [Fe³⁺]/[Feₜₒₜ], where [Feₜₒₜ]=[Fe²⁺]+[Fe³⁺], was found to be approximately 0.7 for both glasses. The T_{g} values of 6 wtFe and 3 wtFe were measured using differential scanning calorimetry (DSC), and found to be 926 K and 921 K, respectively.

The obtained glasses were cut in cylinders and then ground by a six-step procedure with SiC paper under ethanol, followed by polishing with 1 μm diamond suspension. Heat-treatments in the H₂/N₂ (1/99) atmosphere were conducted at 1 atm in an electrical furnace. The glass samples were inserted into the cold furnace and the gas-flow was turned on. Heating and cooling of the furnace were conducted at 10 K/min. Treatments in CO/CO₂ (98/2) were conducted similarly, but the heating and cooling rate was 5 K/min. The partial pressure of oxygen was kept at a known value in the H₂/N₂ (1/99) atmosphere by using a Fe₃O₄/Fe₂O₃ redox buffer. Fe₂O₃ and Fe₃O₄ powders were mixed in the molar ratio 3:2 and placed inside the furnace together with the samples. In the CO/CO₂ (98/2) atmosphere, the oxygen partial pressure was controlled by the CO-00₂—O₂ equilibrium.

Fourier transform infrared (FT-IR) and ultraviolet-visible-near infrared (UV-VIS-NIR) absorption spectra were measured using doubly polished 0.2 mm thick glass slides with Bruker Vertex 70 FT-IR and Analytik Jena UV-VIS-NIR Specord 200 spectrophotometers, respectively. From FT-IR spectra, the permeation of H₂ and CO into the glasses can be investigated as incorporated OH and CO₃ groups are detectable in IR spectra. UV-VIS-NIR spectra were recorded to determine the change in the iron redox state as a function of heat-treatment conditions. The Fe²⁺ ion has a maximum absorption peak near 1050 nm but the position and intensity of this peak varies with glass composition. The absorption coefficients for our glasses were not known and therefore the absorption coefficient of the Lambert-Beer equation was calculated: A=c·ε·t, where A is absorbance, c the concentration, E the absorption coefficient, and t the sample thickness. By using the [Fe³⁺]/[Feₜₒₜ] ratio and the total iron content, the concentration of ferrous iron was calculated in the untreated 6 wtFe glass. Plotting the absorbance near 1050 nm versus the sample thickness (0.12, 0.20, 0.40, and 0.80 mm) gave a linear relation (R²=0.997). From the slope of this plot (c·ε), the absorption coefficient was calculated to be 3.90 L mol⁻¹ mm⁻¹.

To study the cationic diffusion processes, compositional analysis of the glass surfaces was carried out using electron-gas secondary neutral mass spectroscopy (SNMS) with an INA 3 (Leybold AG) instrument. The analyzed area had a diameter of 5 mm and was sputtered using Kr plasma with an energy of ˜500 eV. The time dependence of the sputter profiles was converted into depth dependence by measuring the depth of the crater at 10 different locations on the same sample with a Tencor P1 profilometer.

Two properties of the heat-treated glasses were tested. Vickers hardness was measured 25 times for each sample using a Struers Duramin 5 microindentor at a load of 0.25 N and a hold time at the maximum load of 5 seconds. The lengths of the indentation diagonals were measured using an optical microscope (reflection method). Chemical durability was tested by measuring leached amounts of Na⁺ and Mg²⁺ ions after dissolution in 0.25 M HCl and KOH solutions. The samples were immersed in plastic containers with 20 cm³ test solution for each 1 cm² of the glass surface area. The containers were mounted on a thermostatic shaking assembly at 90° C. (agitated at 100 ppm) and after 12 h, the samples were removed from the solutions. Atomic absorption spectroscopy (AAnalyst 100, Perkin Elmer) was employed to measure the concentrations of Na⁺ and Mg²⁺ in the test solutions.

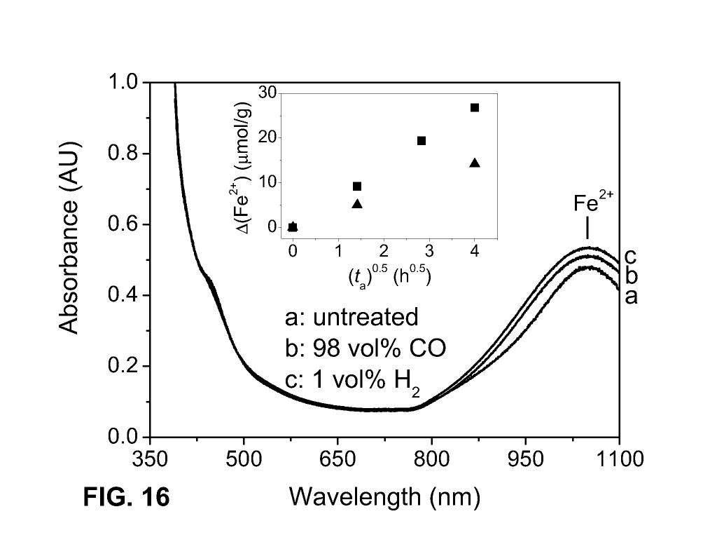

Results and discussion. FIG. 16 shows UV-VIS-NIR spectra of glasses heat-treated at T_{g} for 16 h in H₂/N₂ (1/99) or CO/CO₂ (98/2), respectively. A maximum absorption peak is seen near 1050 nm, which is attributed to the existence of the Fe²⁺ ions. When the glass is heat-treated in H₂/N₂ (1/99) or CO/CO₂ (98/2) for a given duration, the intensity of the Fe²⁺ band increases, indicating that Fe³⁺ is reduced to Fe²⁺. The change in Fe²⁺ concentration (Δ(Fe²⁺)) increases approximately linearly with the square root of the heat-treatment duration (tₐ^{0.5}), implying that diffusion-limited kinetics occurs (see inset of FIG. 16). The effect of heat-treatment of the glasses was measured by IR (not shown). Bands at 3550 and 2850 cm⁻¹ are caused by O—H stretching vibrations of weakly and strongly hydrogen-bonded OH species, respectively. Bands near 1860 and 1630 cm⁻¹ can be assigned to combination modes and overtones of the silica glass matrix. The bands positioned at 1510 and 1425 cm⁻¹ are assigned to vibrations of chemically dissolved carbonate species. One of the carbonate oxygens is attached to a tetrahedral site via a non-bridging oxygen (NBO). This complex is associated with Ca²⁺. The following reactions account for the observed bands as a result of treatments in H₂/N₂ (1/99) and CO/CO₂ (98/2):

H₂+2 NaFe³⁺O₂+4 SiOSi→4 SiO(Fe²⁺)_{0.5}+2SiOH+2SiONa

CO+2 NaFe³⁺O₂+SiOCa_{0.5}+3SiOSi→4SiO(Fe²⁺)_{0.5}+SiCO₃Ca_{0.5+2}SiONa

In the notation, the formulas depict the bonding environment of the oxygen anions. NaFe³⁺O₂ represents a Fe³⁺, which is tetrahedrally coordinated with oxygen and charge-balanced by Na⁺. SiOSi corresponds to a bridging oxygen connecting two silica tetrahedra. SiOH is a silica tetrahedron containing a hydroxyl group. SiCO₃Ca_{0.5} is a carbonate species connected to a NBO and Ca²⁺. SiO(Fe²⁺)_{0.5}, SiONa, and SiOCa_{0.5} represent that Fe²⁺ (octahedral coordination), Na⁺, and Ca²⁺ are connected to a NBO, respectively. In summary, the results show that both H₂ and CO are capable of permeating into the glass. Fe³⁺ is reduced to a greater extent in H₂/N₂ (1/99) than in CO/CO₂ (98/2), even though the CO partial pressure is much higher than that of H₂. This is explained by the faster permeation rate of a H₂ molecule due to its smaller size. Based on the covalent radii of H, C (sp), and O, we have calculated the lengths of H₂ and CO molecules to be 1.2 and 2.7 Å, respectively.

The SNMS depth profile of the 6 wtFe glass heat-treated in CO/CO₂ (98/2) at its T_{g} for 16 h is not shown. However, a pronounced decrease of the concentration of Mg²⁺, Ca²⁺, and Fe²⁺ towards the surface is observed (thickness: 300-350 nm). Na⁺ also diffuses towards the interior. Even though alkali ions are normally found to be faster than earth alkaline ions in glasses due to their lower charge, the diffusion depth of Na⁺ is smaller than that of Mg²⁺, Ca²⁺, and Fe²⁺, which is in agreement with the above studies. The inward diffusion occurs to charge-balance the outward flux of electron holes, and the charge might be most effectively transferred by the divalent cations.

It should be noted that an enrichment of Na⁺ is observed in the depth interval from 100 to 150 nm. This is ascribed to the depletion of Mg²⁺, Ca²⁺, and Fe²⁺ ions in this range because their depletion causes a relatively high concentration of Na⁺ ions. It should also be noted that the surface depletion of network-modifying cations is not due to the polishing procedure for two reasons. First, the glass was ground using SiC papers under ethanol and polished using a diamond paste, i.e., no leaching of cations should occur. Second, a SNMS profile of the untreated glass does not show any inward diffusion of cations.

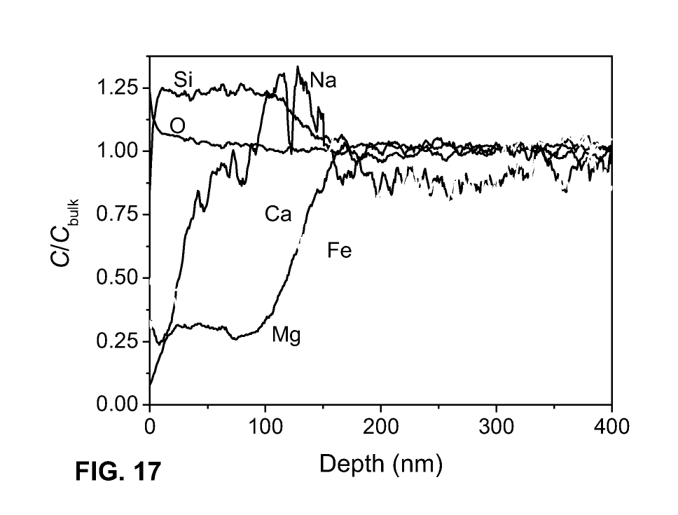

The SNMS profile of the glass treated in CO/CO₂ (FIG. 17) indicates that the mechanism of Fe³⁺ reduction in CO/CO₂ (98/2) is the same as that in H₂/N₂ (1/99). The internal reduction of Fe³⁺ generates electron holes (h^{}). An outward flux of h^{} occurs, which is driven by the gradient in oxygen activity across the reaction zone. h^{} are filled by electrons released by ionic oxygen at the surface since oxygen is released into the reducing atmosphere as CO₂. The outward flux of h^{} is accompanied by inward flux of network-modifying cations to maintain the charge-balance. Hence, the inward cationic diffusion is driven by reduction of the high valence to the low valence state of the polyvalent cation. To explore whether or not the reaction is rate-limited by the diffusion of divalent cations, diffusion coefficients for the divalent cations should be calculated and compared to known values of diffusion coefficients for divalent cations in similarly polymerized glasses. The diffusion coefficient for a divalent cation (D_{M}_{²⁺}) can be calculated by using the following equation:

$${D}_{{M}^{2 +}} = \frac{Δ {ξ}^{2}}{{X}_{{M}^{2 +}} Δ t ln ( \frac{{p}_{{O}_{2} }^{″}}{{p}_{{O}_{2}}^{′}} )} ,$$

where Δξ is the thickness of the modifier layer, Xₘ_{²⁺} is the cation mole fraction of the divalent cation M²⁺, Δt is the reaction time, p′_{O}_{₂} is the partial pressure (i.e., activity) of oxygen at the free surface, and p″_{O}_{₂} is partial pressure of oxygen at the internal reaction front. p′_{O}_{₂} is fixed by the CO—CO₂—O₂ equilibrium and is equal to 5·10⁻²⁷ bar at T_{g}=653° C. p″_{O}_{₂} depends on the initial iron redox ratio and is calculated to be approximately 5·10⁻³ bar at T_{g}=653° C. Inserting these values into the above equation gives a diffusion coefficient of Fe²⁺ cations in CO/CO₂ (98/2) of ˜1·10⁻¹⁸ m²/s. The value agrees well with diffusion measurements for divalent, network-modifying cations in glasses of similar polymerization. This provides clear evidence for the mechanism. Hence, both CO permeation and outward flux of electron holes contribute to the reduction of Fe³⁺. In summary, the inward cationic diffusion causes the creation of a silica-rich surface layer in the iron-containing glasses. For the 3 wtFe glass treated in CO/CO₂ (98/2) at its T_{g} for 16 h, the layer thickness is ˜200 nm. This implies that when lowering the concentration of Fe³⁺ ions, the extent of divalent ionic diffusion decreases, and therefore, the layer becomes thinner. The layer is also created when the 6 wtFe glass is heat-treated in H₂/N₂ (1/99). However, in this case the thickness is ˜600 nm at T_{g} for 16 h, which gives a value of D_{M}_{²⁺} of ˜5·10⁻¹⁸ m²/s. This suggests that H₂ be more effective in creating the silica-rich surface than CO even though the oxidation potential of CO is larger than that of H₂ at 926 K (T_{g}). The difference in the layer thickness must then be due to the difference in size of the two gaseous molecules. To neutralize the electron holes at the surface, H₂ and CO molecules must first penetrate into the uppermost surface layer, subsequently be dissolved in the structure, and simultaneously contact and reduce the ferric ions in the glass structure. The penetration, and hence, reduction process is easier when the molecule is small.

The hardness and chemical resistance of the untreated and heat-treated samples are displayed in Table 10. From the structural point of view, the earth alkaline and alkali cations disrupt the continuous Si—O random network, and so introduce NBOs to the glasses. Their removal from the surface clearly increases the hardness and chemical resistance of the glasses. The increase is most pronounced as a result of the H_{z}-treatment as treatment in this atmosphere creates the thickest silica-rich layer.

TABLE 10
Effect of the atmosphere of the heat-treatment on the Vickers
hardness (Hᵥ) and chemical durability of the 6wtFe glasses.

| Property | Untreated | 98 vol % CO | 1 vol % H₂ |
|---|---|---|---|
| Hᵥ (GPa) | 8.9 ± 0.2 | 9.3 ± 0.2 | 9.9 ± 0.3 |
| C(Na⁺)_{acid} (mg/L) | 8.7 ± 0.3 | 5.1 ± 0.2 | 1.9 ± 0.1 |
| C(Mg²⁺)ₐₗₖₐₗᵢ (mg/L) | 2.4 ± 0.3 | 1.6 ± 0.1 | 1.3 ± 0.1 |

The treated samples have all been heated at T_{g} = 926 K for 16 h. Chemical durability of the glasses is expressed by the leached amount of Na⁺ after 12 h in 0.25M HCl solution (C(Na⁺)_{acid}) and Mg²⁺ after 12 h in 0.25M KOH solution (C(Mg²⁺)ₐₗₖₐₗᵢ).

### Conclusions. A silica-rich surface layer can be created by heat-treating an iron-bearing glass at its T_{g} in both CO- and H₂-containing atmospheres. The layer is created due to the inward diffusion of network-modifying cations. By calculating the diffusion coefficient for the divalent cations, we have clarified the mechanism of the inward diffusion. The glass surface becomes structurally more polymerized due to the removal of network-modifying cations from the surface. Consequently, the hardness and chemical durability of the glasses are enhanced. In addition, it is found that the extent of the inward diffusion is larger as a result of the H₂-treatment than of the CO-treatment. This is attributed to the fact that H₂ has a smaller size than CO, so that the former more readily reduces the ferric ions in the surface structure than the latter.

### On-Going Experimental Work

For the on-going experimental work of the inventors, the following points of consideration may or have been investigated in further details by experimental and/or theoretical means and methods:
Further elucidation of different glass compositions for achieving a silica nanolayer. This includes:
   Finding the lowest limit of the concentration of the polyvalent ion in the glass to enable the invention, in particular for practical implementation.
   Creating a SiO₂-rich surface nanolayer in normal medical glasses (borosilicate glasses, wt %: 75-80 SiO₂, 10-13 B₂O₃, 2-5 Al₂O₃, 4-7 Na₂O, 0-2 CaO) or in window glasses by adding a polyvalent element.
Further elucidation of the impact on the concentration of the H₂ in the gas mixture affecting the formation of the nanolayer.
   Dependent on glass composition, H₂ will be more or less soluble. Hence, different conc. of H₂ will result in inward diffusion (probably: when H₂ is more soluble, a lower H₂ conc. is needed to obtain inward diffusion).
Further elucidaton of the physical and mathematic model for describing the mechanism of the inward diffusion in glasses.
Characterizing the nanostructured layer more precisely.
   TEM-images of the surface layers (untreated, periclase layer and silica-rich layer) can give insight into the structure of these layers.
   XPS: characterization of the uppermost (few nm) layer
   Systematic CEMS (conversion electron Mössbauer spectroscopy) investigations
Finding the optimum temperature and duration of heat-treatment for achieving the nanolayer on different glass types.
Further elucidation of the created nanolayers impact on the properties of glasses.
   hardness (by nanoindentation)
   chemical durability in different solutions
   optical: antireflection, IR-absorption (heat), refractive index, etc.
   T_{g} of the surface layer
   high temperature stability: heat modified surface in air at elevated temperature and measure roughness before and after heating.
Analyze whether a silica-rich nanolayer can be created on glass fibres that are used in composite materials.

It should be noted that embodiments and features described in the context of one of the aspects of the present invention also apply to the other aspects of the invention.

All patent and non-patent references cited in the present application, are hereby incorporated by reference in their entirety.

### REFERENCES

Pind M. and Sørensen P. M. (2004) Effect of the redox state, iron content and silica/alumina ratio on the crystallization be-haviour of iron-bearing aluminosilicate glasses, Master thesis, Aalborg University, Denmark.
V. Rigato, G. Della Mea, Carlo G. Pantano (1994) “Hydrogen profiles in the surface of reduced lead-silicate glasses”, Surface and Interface Analysis, Volume 21, Issue 2, Pages 144-149.
Dériano S., Rouxel T., Malherbe S., Rocherullé J., Duisit G., Jézéquel G. (2004) “Mechanical strength improve-ment of a soda-lime-silica glass by thermal treatment under flowing gas”, Journal of the European Ceramic Society, 24, 2803-2812.
Gaillard F., Schmidt B., Mackwell S., and McCammon C. (2003) “Rate of hydrogen-iron redox exchange in silicate melts and glasses”, Geochimica et Cosmochimica Acta, 67, 2427-2441.
Gersten J. I. and Smith F. W. (2001) The Physics and Chemistry of Materials, John Wiley & Sons, New York USA.
L. D. Pye, A. Montenero, and I. Joseph (2005) Properties of Glass-Forming Melts, CRC Press.
J. E. Shelby (2005) Introduction to Glass Science and Technology, The Royal Society of Chemistry, Cambridge, UK.
Stanworth J. E. (1971) “Oxide Glass Formation from the Melt”, Journal of the American Ceramic Society, 54, 61-63.
Vogel W. (1994) Glass Chemistry, Springer Verlag, Berlin, Germany.
Zachariasen W. H. (1932) “The Atomic Arrangement in Glass”, Journal of the American Chemical Society, 54, 3841-3851.
Zotov N., Yanev Y., Epelbaum M., and Konstantinov L. (1992) “Effect of water on the structure of rhyolite glasses—X-ray diffraction and Raman spectroscopy studies”, Journal of Non-Crystalline Solids, 142, 234-246.

1. A silicate glass article comprising a bulk part, a surface region, and network-modifying cations (NMC):
wherein the silicate Mass article has a weight percentage of polyvalent metal oxides of 0.5-30%;
wherein the silicate glass article comprises a polyvalent element selected from the group consisting of: Au³⁺, Au²⁺, Au⁺, Ir³⁺, Pt²⁺, Pd²⁺, Ni²⁺, Rh⁺, Rh³⁺, Co²⁺, Co³⁺, Mn⁴⁺, Mn³⁺, Ag³⁺, Ag²⁺, Ag⁺, Se⁶⁺, Se⁴⁺, Se, Ce⁴⁺, Cr⁶⁺, Cr⁴⁺, Cr³⁺, Cr²⁺, Sb⁵⁺, Sb³⁺, Cu³⁺, Cu²⁺, Cu⁺, U⁴⁺, Fe⁶⁺, Fe³⁺, Fe²⁺, As⁵⁺, As³⁺, As, Te⁷⁺, Te⁴⁺, Te, V⁵⁺, V⁴⁺, V³⁺, Bi⁴⁺, Bi³⁺, Bi²⁺, Bi⁺, Eu³⁺, Ti⁴⁺, Ti³⁺, Sn⁴⁺, Sn²⁺, Zn²⁺, and Cd²⁺;
wherein the concentration of the network-modifying cations in the surface region is lower than in the bulk part;
wherein the silicate bridging-oxygen content is higher in the surface region than in the bulk region; and
wherein the composition in the surface region of the network-modifying cations is a consequence of an inward diffusion.

2-28. (canceled)

29. The silicate glass article according to claim 1, wherein the silicate glass article has a weight percentage of silica of at least 50%.

30. The silicate glass article according to claim 1, wherein the silicate glass comprises transition metallic cations.

31. The silicate glass article according to claim 30, wherein at least some of the transition metallic cations are network-modifying cations (NMC).

32. The silicate glass article according to claim 30, wherein the transition metallic cations are selected from a group consisting of: Ti⁴⁺, Ti³⁺, V⁵⁺, V⁴⁺, V³⁺, Cr⁶⁺, Cr⁵⁺, Cr³⁺, Mn⁷⁺, Mn⁶⁺, Mn⁵⁺, Mn⁴⁺, Mn³⁺, Fe⁵⁺, Fe⁴⁺, Fe³⁺, Co⁴⁺, Co³⁺ and Ni³⁺.

33. The silicate glass article according to claim 30, wherein the transition metallic cations are selected from a group consisting of: Ti²⁺, V²⁺, Cr²⁺, Mn²⁺, Fe²⁺, Co²⁺, Ni²⁺, Cu²⁺, Zn²⁺, Zr²⁺, Nb²⁺, Mo²⁺, Ru²⁺, Rh²⁺, Pd²⁺, Ag²⁺, Cd²⁺, Ta²⁺, W²⁺, Re²⁺, Os²⁺, Ir²⁺, Pt²⁺, Hg²⁺ and Ra²⁺.

34. The silicate glass article according to claim 1, wherein at least some of the network-modifying cations (NMC) are from Group IIa in the Periodic Table.

35. The silicate glass article according to claim 1, wherein said silicate glass article is a glass container, a glass fiber, art glass, or a glass container capable of storing a liquid.

36. A process for modifying a surface region of a silicate glass article, said process comprises the step of heat-treating the silicate glass article in an atmosphere comprising a reducing gas,
wherein the silicate glass article has a weight percentage of polyvalent metal oxides of 0.5-30%,
wherein the silicate glass article comprises a polyvalent element selected from the group consisting of: Au³⁺, Au²⁺, Au⁺, Ir³⁺, Pt²⁺, Pd²⁺, Ni²⁺, Rh⁺, Rh³⁺, Co²⁺, Co³⁺_{, Mn}⁴⁺, Mn³⁺, Ag³⁺, Ag²⁺, Ag⁺, Se⁶⁺, Se⁴⁺, Se, Ce⁴⁺, Cr⁶⁺, Cr⁴⁺, Cr³⁺, Cr²⁺, Sb⁵⁺, Sb³⁺, Cu³⁺, Cu²⁺, Cu⁺, U⁴⁺, Fe⁶⁺, Fe³⁺, Fe²⁺, As⁵⁺, As³⁺, As, Te⁷⁺, Te⁴⁺, Te, V⁵⁺, V⁴⁺, V³⁺, Bi⁴⁺, Bi³⁺, Bi²⁺, Bi⁺, Eu³⁺, Ti⁴⁺, Ti³⁺, Sn⁴⁺, Sn²⁺, Zn²⁺, and Cd²⁺,
wherein the heat-treatment is performed at 0.7-2.0 times the glass transition temperature (T_{g}) of the silicate glass,
said process resulting in an inward diffusion of the network-modifying cations (NMC) into deeper regions of the silicate glass article, whereby the concentration of the network-modifying cations in the surface region is lowered, said process resulting in the formation of a silicate bridging-oxygen content that is substantially higher in the surface region than in the bulk region.

37. The process according to claim 36 wherein the reducing gas is a mixture of reducing gasses.

38. The process according to claim 36, wherein the reducing gas is further mixed with one or more inert gasses.

39. The process according to claim 36, wherein the atmosphere comprises a mixture of nitrogen gas and hydrogen gas.

40. The process according to claim 36, wherein the atmosphere comprises a mixture of carbon monoxide gas and carbon dioxide gas.

41. The process according to claim 36, wherein the atmosphere comprises a mixture of gasses selected from a group consisting of: SbH₃, AsH₃, B₂H₆, CH₄, PH₃, SeH₂, SiH₄, SH₂, SnH₄, Cl₂, NO, N₂O, CO, H₂, N₂O₄, SO₂, C₂H₄, and NH₃.

42. The process according to claim 36, wherein the heat-treatment is performed so as to obtain a thickness of said surface region of at least 100 nm.
